(19) United States
(12) Patent Application Publication
(10) Pub. No.: US 2017/0028676 A1
(43) Pub. Date: Feb. 2, 2017

(54) ANTIREFLECTION FILM AND FUNCTIONAL GLASS

(71) Applicant: FUJIFILM Corporation, Tokyo (JP)

(72) Inventors: Hideki YASUDA, Ashigarakami-gun (JP); Ryou MATSUNO, Ashigarakami-gun (JP)

(73) Assignee: FUJIFILM Corporation, Tokyo (JP)

(21) Appl. No.: 15/290,415

(22) Filed: Oct. 11, 2016

Related U.S. Application Data
(63) Continuation of application No. PCT/JP2015/001993, filed on Apr. 9, 2015.

(30) Foreign Application Priority Data
Apr. 14, 2014 (JP) 2014-082776

(51) Int. Cl. B32B 7/02; B32B 27/20; B32B 23/04; B32B 23/18; B32B 27/36

(52) U.S. Cl. CPC B32B 7/02; B32B 23/18; B32B 27/36; B32B 23/04; B32B 27/20; B32B 2264/102; B32B 2307/412; B32B 2307/418; B32B 2419/00; B32B 2605/006

(57) ABSTRACT

An antireflection film includes an antireflection structure which has different reflectivity with respect to light to be incident on front and back surfaces, and includes a silver nano-disk layer formed by dispersing a plurality of silver nano-disks in a binder, and a layer of low refractive index which is formed on a surface of the silver nano-disk layer and has a refractive index smaller than a refractive index of the transparent substrate, and in which a ratio of a diameter of the silver nano-disk to a thickness is greater than or equal to 3, an area ratio of the silver nano-disk to the silver nano-disk layer is from 10% to 40%, and a pair of antireflection films having reflection conditions different from each other adhere to both surfaces of glass.

### CROSS-REFERENCE TO RELATED APPLICATIONS

This application is a Continuation of PCT International Application No. PCT/JP2015/001993 filed on Apr. 9, 2015, which claims priority under 35 U.S.C. §119(a) to Japanese Patent Application No. 2014-082776 filed on Apr. 14, 2014. Each of the above applications is hereby expressly incorporated by reference, in its entirety, into the present application.

### BACKGROUND OF THE INVENTION

1. Field of the Invention

The present invention relates to an antireflection film having an antireflection function with respect to an incidence ray and a functional glass to which the antireflection film is applied.

2. Description of the Related Art

An optical member including an antireflection film which includes a dielectric multilayer, or a visible light wavelength absorption layer formed of a metal fine particle layer in a multilayer is known as an antireflection optical member with respect to visible light.

In JP2003-139909A, JP2001-324601A, and the like, an antireflection film having a function of reducing external light reflection, an antistatic function, a function of shielding an electromagnetic wave, and the like has been proposed in order to be applied to a glass surface of a display.

In window glass for building material use or on-board use, the fact that external light or illumination is reflected on a surface and reflected glare occurs as an image, and thus, visibility decreases becomes a problem, and in order to reduce the reflected glare due to the reflection, the glass surface is coated with a thin film, and thus, an antireflection structure is provided (for example, JP2008-247739A).

Further, so-called mirror glass, in which the visibility from one side is high, and the visibility from the other side is suppressed, has been proposed as the window glass for building material use or on-board use in JP1995-25647A (JP-H07-25647A), JP1999-157880A (JP-H11-157880A), and the like.

### SUMMARY OF THE INVENTION

In the window glass for building material use or on-board use, in a case where the window glass is seen from one surface, it is desirable that reflectivity is minimized as possible from the viewpoint of ensuring a clear visual field. On one hand, in a case where the window glass is seen from the other surface, it is desirable that a certain degree of reflection occurs in order to ensure privacy and to prevent collision. For example, in a shop window or the like, an antireflection treatment is performed in order to reduce reflected glare at the time of seeing the inside from the outside, and a certain degree of reflected glare may occur at the time of seeing the outside from the inside such that scenery from the outside is not remarkable or the presence of the window is easily recognized by suppressing an antireflection effect from the viewpoint of preventing collision. On the other hand, in car window, it is necessary that the reflected glare decreases and a visual field is excellent at the time of seeing the outside from the inside, and it is preferable that the reflected glare occurs at the time of seeing the inside from the outside in order to ensure privacy.

The antireflection film disclosed in JP2003-139909A and JP2001-324601A has electromagnetic wave shielding properties, and the antireflection film includes a conductive layer such as a transparent conductive film or a silver film, and thus, a radio wave of a portable phone or the like is not transmitted, and thus, is not suitable for application to a car window or window glass of a building.

In JP2008-247739A, a method of preparing at least a part of layer by thermal decomposition is proposed in order to increase mechanical and chemical durability of glass, but setting the reflectivity to be different on each of the surfaces is not disclosed.

In JP1995-25647A (JP-H07-25647A) and JP1999-157880A (JP-H11-157880A), mirror glass is disclosed, but metal having a large light absorbance is not contained in a functional film in both of JP1995-25647A (JP-H07-25647A) and JP1999-157880A (JP-H11-157880A), and thus, a high transmittance of greater than or equal to 80% is not able to be obtained, and a metal film is not included, and thus, a radio wave transmittance is not obtained.

The present invention has been made in consideration of such circumstances described above, and an object of the present invention is to provide functional glass having different reflectivity on each of the surfaces and a radio wave transmittance, in which light transmittance is sufficiently high on one surface and reflected glare occurs on the other surface, and to provide an antireflection film in order to apply a functionality to the glass.

An antireflection film of the present invention preventing an incidence ray having a wavelength λ from being reflected, comprising: a transparent substrate; and an antireflection structure disposed on one surface of the transparent substrate, in which when reflectivity in a case in which the light having a wavelength λ is incident on the antireflection structure from a front surface side is set to A, and reflectivity in a case in which the light is incident from a back surface side is set to B, A and B satisfy Relational Expression (1) or (2) described below,

A<1.0% and B/A>2 (1)

B<1.0% and A/B>2 (2),

the antireflection structure includes a silver nano-disk layer formed by dispersing a plurality of silver nano-disks in a binder, and a layer of low refractive index which is formed on a surface of the silver nano-disk layer and has a refractive index smaller than a refractive index of the transparent substrate, a ratio of a diameter of the silver nano-disk to a thickness is greater than or equal to 3, and an area ratio of the silver nano-disk to the silver nano-disk layer is from 10% to 40%.

In the above description, satisfying Expression (1) or (2) indicates that in the front surface side and the back surface side (the transparent substrate side) of the antireflection structure, reflectivity on a surface side on which reflectivity with respect to light having a wavelength λ is lower is less than 1.0%, and reflectivity on the other surface side is greater than two times the lower reflectivity.

It is preferable that the thickness of the layer of low refractive index is less than or equal to 400 nm.

Further, it is more preferable that the thickness of the layer of low refractive index is a thickness in which an optical path length is less than or equal to λ/4. Here, the optical path length indicates a value obtained by multiplying a physical thickness and a refractive index together.

In principle, it is optimal that the thickness of the layer of low refractive index is an optical path length of λ/8, and the optimal value is changed in a range of approximately λ/16 to λ/4 according to the conditions of the silver nano-disk layer, and thus, the thickness may be suitably set according to a layer configuration.

The incidence ray having a wavelength λ is light to be prevented from being reflected in the antireflection film of the present invention, and is different according to the application, and visible light (380 nm to 780 nm) is mainly used as a target in the present invention.

“The silver nano-disks being dispersed” indicates that greater than or equal to 80% of the silver nano-disks are arranged separately from each other. “Being arranged separately from each other” indicates a state in which there is an interval between the closest fine particles of greater than or equal to 1 nm. It is more preferable that the interval between the closest fine particles of the fine particles arranged separately from each other is greater than or equal to 10 nm.

It is preferable that the transparent substrate is a PET film or a TAC film.

The layer of low refractive index is able to be formed by dispersing a plurality of hollow silicas in a binder.

It is preferable that the antireflection structure includes a layer of high refractive index having a refractive index larger than the refractive index of the transparent substrate between the transparent substrate and the silver nano-disk layer.

It is preferable that the antireflection structure includes a hard coat layer between the transparent substrate and the silver nano-disk layer.

A functional glass of the present invention, comprising: a glass plate; a first antireflection film adhering to one surface of the glass plate; and a second antireflection film adhering to the other surface of the glass plate, in which the first antireflection film and the second antireflection film are the antireflection film of the present invention and have reflection conditions different from each other, and when reflectivity in a case in which light having a wavelength λ is incident from the one surface side is set to C, and reflectivity in a case in which the light is incident from the other surface side is set to D, C and D satisfy Relational Expression (3) or (4) described below.

C<2.0% and D/C>2 (3)

D<2.0% and C/D>2 (4)

Here, “having reflection conditions different from each other” indicates that the value of reflectivity A on the front surface of the antireflection structure and the value of reflectivity B on the back surface are not completely coincident with the magnitude relationship thereof.

In the antireflection film of the present invention, the antireflection structure has different reflectivity with respect to the incidence ray from the front surface and the back surface, the reflectivity on both surfaces becomes different by adhering the antireflection film of the present invention having reflection conditions different from each other onto both surfaces, and thus, it is possible to provide functional glass in which reflection in a case of being seen from one surface is suppressed and a clear visual field is ensured while maintaining a high light transmittance and a high radio wave transmittance necessary as window glass, and reflected glare due to the reflection occurs at the time of being seen from the other surface, and thus, it is possible to ensure privacy or to prevent collision.

### BRIEF DESCRIPTION OF THE DRAWINGS

FIG. 1A is a schematic view illustrating an embodiment of an antireflection film of the present invention.

FIG. 1B is a diagram for illustrating reflection of an incidence ray on the antireflection film.

FIG. 2A is a sectional view illustrating a first example of a configuration of an antireflection structure.

FIG. 2B is a sectional view illustrating a second example of the configuration of the antireflection structure.

FIG. 2C is a sectional view illustrating a third example of the configuration of the antireflection structure.

FIG. 3 is a schematic view illustrating an embodiment of functional glass of the present invention.

FIG. 4 is an SEM image of a silver nano-disk layer in plan view.

FIG. 5 is a schematic view illustrating an example of a silver nano-disk.

FIG. 6 is a schematic view illustrating another example of the silver nano-disk.

FIG. 7 is a diagram illustrating a simulation of wavelength dependency of a transmittance at each aspect ratio of the silver nano-disk.

FIG. 8 is a schematic sectional view illustrating a presence state of the silver nano-disk layer including the silver nano-disk in the antireflection film of the present invention, and illustrating an angle (θ) between the silver nano-disk layer including the silver nano-disk (parallel to a plane of a substrate) and a main plane of the silver nano-disk (a surface determining an equivalent circle diameter D).

FIG. 9 is a schematic sectional view illustrating a presence state of the silver nano-disk layer including the silver nano-disk in the antireflection film of the present invention, and illustrating a presence region of the silver nano-disk in a depth direction of the antireflection structure of the silver nano-disk layer.

FIG. 10 is a schematic sectional view illustrating another example of the presence state of the silver nano-disk layer including the silver nano-disk in the antireflection film of the present invention.

FIG. 11 is a graph illustrating wavelength dependency of reflectivity on front and back surfaces of functional glass of an example.

### DESCRIPTION OF THE PREFERRED EMBODIMENTS

Hereinafter, embodiments of the present invention will be described.

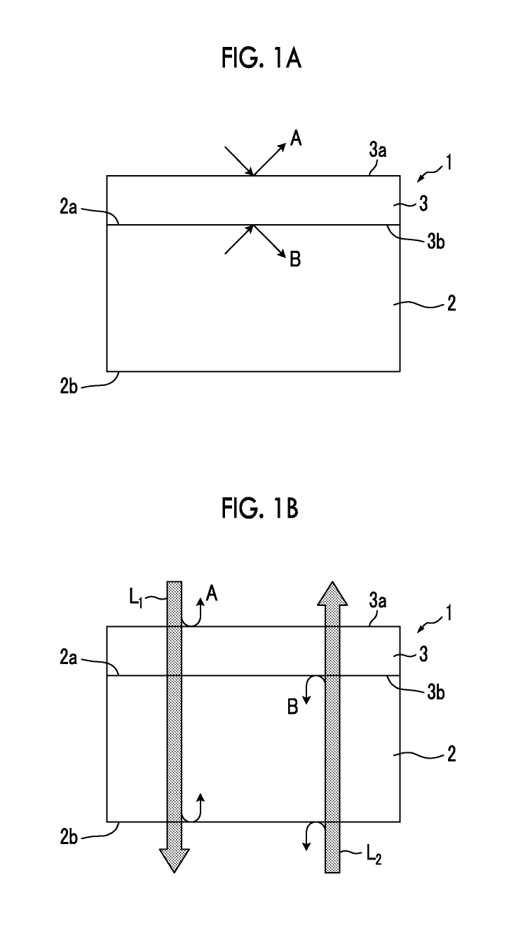

FIG. 1A is a sectional schematic view illustrating a schematic configuration of an antireflection film 1 according to an embodiment of the present invention. As illustrated in FIG. 1A, the antireflection film 1 of this embodiment is a film-like antireflection optical member preventing reflection of an incidence ray having a predetermined wavelength, and includes a transparent substrate 2, and antireflection structure 3 disposed on one surface of the transparent substrate 2.

Then, in the antireflection structure 3, reflectivity A with respect to light having a wavelength λ which is incident from a front surface side and reflectivity B with respect to light having a wavelength λ which is incident from a back surface side (the transparent substrate 2 side) of the antireflection structure 3 satisfy,

A<1.0% and B/A>2 (1)

B<1.0% and A/B>2 (2)

Relational Expression (1) or (2) described above.

That is, in a front surface 3a side and a back surface 3b side (the transparent substrate side) of the antireflection structure 3, reflectivity on a surface side on which the reflectivity with respect to the light having a wavelength λ is lower is less than 1.0%, and reflectivity on the other surface side is greater than two times the lower reflectivity.

As illustrated in FIG. 1B, in light L₁ having a wavelength λ which is incident on the antireflection film 1 from the front surface of the antireflection structure 3, a part thereof is reflected by the antireflection structure 3 with the reflectivity A, a part thereof is reflected on an interface (a substrate back surface) 2b between the transparent substrate 2 and the outside, and a part thereof is mostly output onto the substrate back surface as transmitted light while being absorbed. Similarly, in light L₂ having a wavelength λ which is incident on the antireflection film 1 from the back surface of the transparent substrate 2, a part thereof is reflected on the back surface 2b of the transparent substrate 2, a part thereof is reflected by the antireflection structure 3 with the reflectivity B, and a part is output onto the front surface of the antireflection structure 3 as transmitted light while being absorbed.

In the present invention, a relationship between the reflectivities A and B on the front surface and the back surface of the antireflection structure 3 of the antireflection film 1 is defined, and reflection occurring on the substrate back surface 2b is neglected.

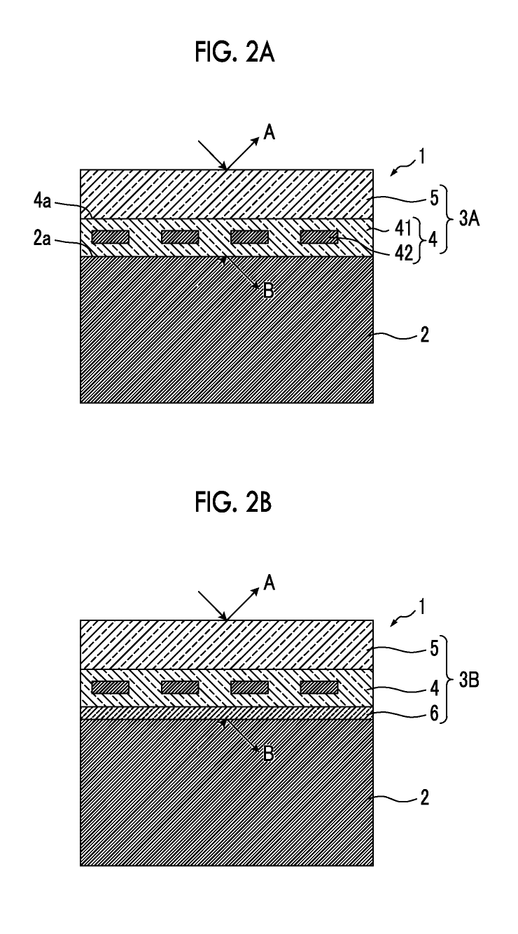

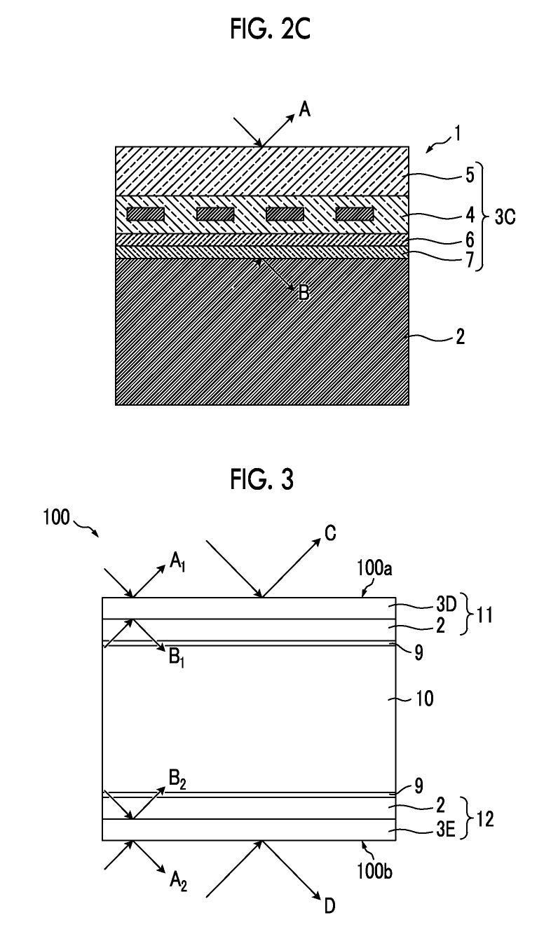

Furthermore, both of the reflectivities are relevant to a case where light vertical to the front surface is incident. After FIG. 1A and FIG. 2A, in order to easily indicate reflection due to incidence from the front surface or the back surface of the antireflection structure, an incidence and reflection axis tilted from the vertical is merely illustrated, for the sake of convenience.

Detailed configuration examples of the antireflection structure 3 are illustrated in FIG. 2A to FIG. 2C. In FIG. 2A to FIG. 2C, the same reference numerals are applied to the same constituents.

As illustrated in FIG. 2A, an antireflection structure 3A of a first example includes a silver nano-disk layer 4 which is formed on the transparent substrate 2 and is formed by dispersing a plurality of silver nano-disks 42 in a binder 41, and a layer of low refractive index 5 which is formed on a front surface 4a side of the silver nano-disk layer 4. Here, the layer of low refractive index 5 is a layer having a refractive index lower than the refractive index of the transparent substrate 2.

As illustrated in FIG. 2B, an antireflection structure 3B of a second example includes a layer of high refractive index 6 having a refractive index higher than the refractive index of the transparent substrate on the transparent substrate 2, and the silver nano-disk layer 4 and the layer of low refractive index 5 are sequentially laminated on the layer of high refractive index 6. By including the layer of high refractive index 6, it is possible to further increase an antireflection effect.

In addition, as illustrated in FIG. 2C, an antireflection structure 3C of a third example includes a hard coat layer 7 on the transparent substrate 2, the layer of high refractive index 6, the silver nano-disk layer 4, and the layer of low refractive index 5 are sequentially laminated on the hard coat layer 7.

The antireflection structure may include other layers insofar as the relationship between the reflectivity A on the front surface side and the reflectivity B on the back surface side satisfies Expression (1) or (2) described above.

A ratio of the diameter of the silver nano-disks 42 in the silver nano-disk layer 4 to the thickness (an aspect ratio) is greater than or equal to 3, and an area ratio of the silver nano-disk in the silver nano-disk layer is from 10% to 40%. Here, greater than or equal to 60% of the total number of the plurality of silver nano-disks 42 which are dispersed and arranged in the binder 41 may satisfy an aspect ratio of greater than or equal to 3.

In a case where the aspect ratio of the silver nano-disk is greater than or equal to 3, it is possible to suppress absorption of light in a visible light range and to sufficiently increase transmittance of light incident on the antireflection film.

In addition, by setting the area ratio to be from 10% to 40%, the reflectivities A and B on the front surface and the back surface are set to be asymmetrical, and thus, a relationship satisfying Expression (1) or (2) described above is able to be obtained.

The main plane of the silver nano-disks 42 is subjected to plane alignment in a range of 0° to 30° with respect to the front surface of the range silver nano-disk layer, and are arranged in the binder 41 separately from each other, and thus, a conductive path is not formed in a plane direction. Furthermore, the silver nano-disks are arranged in a single layer without being superimposed in a thickness direction.

The wavelength λ of the incidence ray is able to be arbitrarily set according to the purpose, and here, is set to 380 nm to 780 nm which is the visibility of the eyes. In general, light having not a single wavelength but a wavelength in a certain wavelength range, for example, white light including a visible range, and the like are used as the incidence ray. The reflectivities A and B described above are defined with respect to a specific wavelength λ in the wavelength range thereof (for example, a center wavelength or a peak wavelength). Here, it is preferable that the reflectivities A and B satisfy Expressions (1) and (2) over a wider wavelength range, for example, a range of greater than or equal to 100 nm.

This antireflection film 1 includes the silver nano-disk layer 4 described above in the antireflection structure 3, and thus, it is possible to apply asymmetry to the reflectivities A and B on the front surface and the back surface and to have a radio wave transmittance.

The antireflection film 1 of the present invention is used by adhering onto a front surface and a back surface of a glass plate to which functionality is planned to be applied. 1) Glass which has a high visible light transmittance from one surface (approximately greater than or equal to 80%) and a clear visual field, 2) glass which has a high radio wave transmittance and does not interrupt a radio wave of a portable phone, and 3) glass in which reflectivity on the other surface is higher than that on one surface, and reflected glare occurs, and thus, it is possible to ensure privacy and to prevent collision are necessary as a functional glass used for window glass or the like, and a technology for each requirement of the related art has been known, but all of the requirements are not able to be simultaneously satisfied. By using the antireflection film of the present invention including the silver nano-disk layer which contains the silver nano-disk in the conditions described above, it is possible to simultaneously satisfy three requirements described above.

An embodiment of the functional glass of the present invention is illustrated in FIG. 3.

Functional glass 100 of the present invention includes a glass plate 10, a first antireflection film 11 adhering onto one surface of the glass plate 10, and a second antireflection film 12 adhering onto the other surface of the glass plate 10.

Both of the first antireflection film 11 and the second antireflection film 12 are one embodiment of the antireflection film of the present invention, and have reflection conditions different from each other. In both of the first antireflection film 11 and the second antireflection film 12, a pressure sensitive adhesive layer 9 is provided on the back surface of the transparent substrate 2, and adheres onto one surface and the other surface of the glass plate 10 through the pressure sensitive adhesive layer 9.

In this functional glass 100, when reflectivity in a case where the light having a wavelength λ is incident from one surface 100a side is set to C, and reflectivity in a case where the light is incident from the other surface 100b side is set to D, C and D satisfy Relational Expression (3) or (4) described below.

C<2.0% and D/C>2 (3)

D<2.0% and C/D>2 (4)

Furthermore, here, as with a case of the antireflection film, the reflectivities C and D are reflectivities with respect to the light having a wavelength λ which is incident vertically to the glass surface.

Further, it is more preferable that C and D satisfy Relational Expression (5) or (6) described below.

C<1.0% and D/C>2 (5)

D<1.0% and C/D>2 (6)

The first antireflection film 11 includes an antireflection structure 3D, reflectivity on a front surface side of the antireflection structure 3D with respect to the light having a wavelength λ is A₁, and reflectivity on a back surface side is B₁, and the reflectivities A₁ and B₁ satisfy Expression (1) or (2) described above.

The second antireflection film 12 includes an antireflection structure 3E, reflectivity on a front surface side of the antireflection structure 3E with respect to the light having a wavelength λ is A₂, reflectivity on a back surface side is B₂, and the reflectivities A₂ and B₂ satisfy Expression (1) or (2) described above.

Here, the first antireflection film 11 and the second antireflection film 12 have reflection conditions different from each other, and thus, at least one of A₁≠ A₂ or B₁≠ B₂ is satisfied.

Furthermore, the transparent substrate 2 of the first antireflection film 11 and the second antireflection film 12 is a film formed of the same material.

For example, when A₁ is 0.5%, B₁ is 1.4%, A₂ is 1.9%, and B₂ is 0.8%, reflectivity C on one surface side of the functional glass 100 with respect to the light having a wavelength λ is 1.3%, and reflectivity D on the other surface side with respect to the light having a wavelength λ is approximately 3.3%.

Here, the glass plate 10 is glass which is used for window of an architectural structure, shop window, car window, or the like.

This functional glass 100 includes the antireflection films 11 and 12 described above, and thus, reflectivities on both surfaces are different from each other, a light transmittance on one surface is sufficiently high, and reflected glare slightly occurs on the other surface. In general, in a case where the reflectivity on the other surface is greater than two times the reflectivity on one surface, a user is able to sufficiently recognize a difference in visibility. In addition, this functional glass 100 has a radio wave transmittance, and is able to transmit a radio wave of a portable phone or the like, and thus, is able to be suitably used for window glass of a building, shop window, car window, or the like.

Hereinafter, each constituent of the antireflection film will be described in detail.

<Transparent Substrate>

The transparent substrate 2 is not particularly limited insofar as the transparent substrate is optically transparent with respect to an incidence ray having a predetermined wavelength λ, and is able to be suitably selected according to the purpose. A transparent substrate having a visible light transmittance of greater than or equal to 70% is preferable as the transparent substrate 2, and a transparent substrate having a visible light transmittance of greater than or equal to 80% is more preferable.

The transparent substrate 2 may be a film-like transparent substrate, may be a transparent substrate having a single layer structure, or may be a transparent substrate having a laminated structure, and the size may be determined according to the application.

Examples of the transparent substrate 2 include a film or a laminated film thereof which is formed of a polyolefin-based resin such as polyethylene, polypropylene, poly-4-methyl pentene-1, and polybutene-1; a polyester-based resin such as polyethylene terephthalate and polyethylene naphthalate; a cellulose-based resin such as a polycarbonate-based resin, a polyvinyl chloride-based resin, a polyphenylene sulfide-based resin, a polyether sulfone-based resin, a polyphenylene ether-based resin, a styrene-based resin, an acrylic resin, a polyamide-based resin, a polyimide-based resin, and a cellulose acetate, and the like. Among them, a triacetyl cellulose (TAC) film and a polyethylene terephthalate (PET) film are particularly preferable.

The thickness of the transparent substrate 2 is generally approximately 10 μm to 500 μm. The thickness of the transparent substrate 2 is more preferably 10 μm to 100 μm, is even more preferably 20 to 75 μm, and particularly preferably 35 to 75 μm. In a case where the thickness of the transparent substrate 2 is sufficiently thick, adhesion failure tends to rarely occur. In addition, in a case where the thickness of the transparent substrate 2 is sufficiently thin, the transparent substrate 2 is not excessively strong as a material, and thus, tends to be easily used for construction at the time of adhering onto window glass of a building material or an automobile as an antireflection film. Further, by setting the transparent substrate 2 to be sufficiently thin, a visible light transmittance tends to increase, and costs of raw materials tend to be suppressed.

In a case where a PET film is used as the transparent substrate 2, it is preferable that the PET film includes an easily adhesive layer on a surface on which the antireflection structure is formed. This is because it is possible to suppress FRESNEL reflection occurring between the PET film and a layer to be laminated and to further increase an antireflection effect by using the PET film including the easily adhesive layer. It is preferable that the film thickness of the easily adhesive layer is set such that an optical path length becomes ¼ with respect to a wavelength at which reflection is planned to be prevented. Examples of the PET film including such an easily adhesive layer include LUMIRROR manufactured by TORAY INDUSTRIES, INC., COSMOSHINE manufactured by TOYOBO CO., LTD., and the like.

<Silver Nano-Disk Layer>

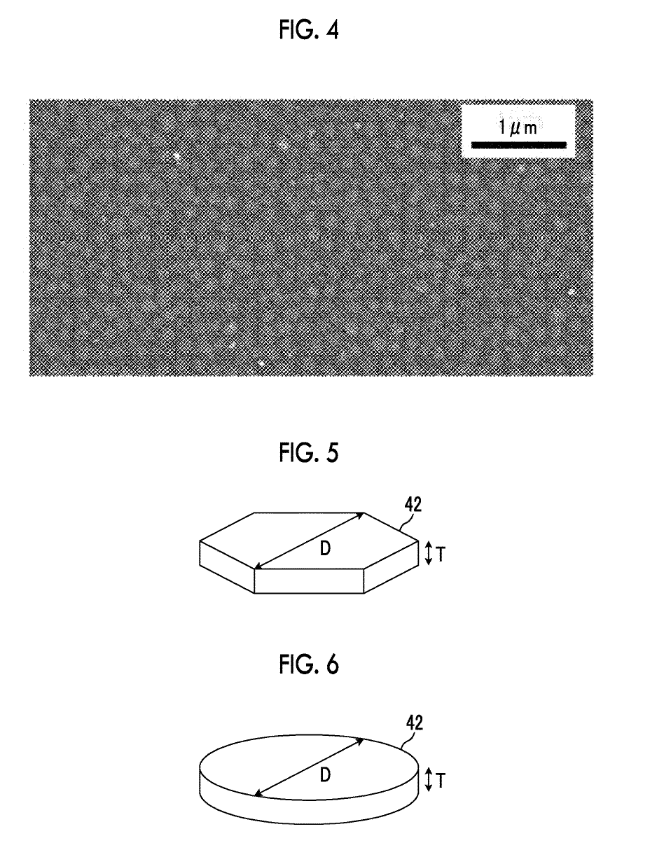

The silver nano-disk layer 4 is a layer formed by containing the plurality of silver nano-disks 42 in the binder 41. FIG. 4 is an SEM image of the silver nano-disk layer in plan view. As illustrated in FIG. 4, the silver nano-disks 42 are dispersed and arranged separately from each other.

—Silver Nano-Disk—

As described above, the plurality of silver nano-disks 42 contained in the silver nano-disk layer 4 are flat plate particles including two facing main planes. It is preferable that the silver nano-disks 42 are segregated on one surface of the silver nano-disk layer 4.

Examples of the shape of the main plane of the silver nano-disks 42 include a hexagonal shape, a triangular shape, a circular shape, and the like. Among them, from the viewpoint of a high visible light transmittance, it is preferable that the shape of the main plane is a hexagonal or more multiangular shape to a circular shape, and it is particularly preferable that the shape of the main plane is a hexagonal shape as illustrated in FIG. 5 or a circular shape as illustrated in FIG. 6.

Two or more types of silver nano-disks having a plurality of shapes may be used by being mixed.

Herein, the circular shape indicates a shape in which the number of sides having a length of greater than or equal to 50% of the average equivalent circle diameter described below is 0 per one silver nano-disk. The silver nano-disk having a circular shape is not particularly limited insofar as the silver nano-disk has a round shape without any angle at the time of observing the silver nano-disk from an upper portion of the main plane by using a transmission type electron microscope (TEM).

Herein, the hexagonal shape indicates a shape in which the number of sides having a length of greater than or equal to 20% of the average equivalent circle diameter described below is 6 per one silver nano-disk. Furthermore, the same applies to other multiangular shapes. The silver nano-disk having a hexagonal shape is not particularly limited insofar as the silver nano-disk has a hexagonal shape at the time of observing the silver nano-disk from an upper portion of the main plane by using a transmission type electron microscope (TEM), and is able to be suitably selected according to the purpose, and for example, the angle of the hexagonal shape may be an acute angle or may be a blunt angle, but it is preferable that the angle becomes a blunt angle from the viewpoint of reducing absorption in a visible light range. The degree of the blunt angle is not particularly limited, and is able to be suitably selected according to the purpose.

[Average Particle Diameter (Average Equivalent Circle Diameter) and Coefficient of Variation]

The equivalent circle diameter indicates a diameter of a circle having an area identical to a projection area of each particle. The projection area of each particle is able to be obtained by a known method in which an area on an electron micrograph is measured and is corrected at an imaging magnification. In addition, in the average particle diameter (the average equivalent circle diameter), a particle diameter distribution (a particle size distribution) is obtained by the statistics of an equivalent circle diameter D of 200 silver nano-disks, and the arithmetic average is able to be calculated. A coefficient of variation of the particle size distribution of the silver nano-disks is able to be obtained by a value (%) which is obtained by dividing the standard deviation of the particle size distribution by the average particle diameter (the average equivalent circle diameter) described above.

In the antireflection film of the present invention, the coefficient of variation of the particle size distribution of the silver nano-disks is preferably less than or equal to 35%, is more preferably less than or equal to 30%, and is particularly preferably less than or equal to 20%. It is preferable that the coefficient of variation is less than or equal to 35% from the viewpoint of reducing absorption of a visible light ray in the antireflection structure.

The size of the silver nano-disk is not particularly limited, and is able to be suitably selected according to the purpose, and the average particle diameter is preferably 10 to 500 nm, is more preferably 20 to 300 nm, and is even more preferably 50 to 200 nm.

[Thickness and Aspect Ratio of Silver Nano-Disk]

In the antireflection film of the present invention, a thickness T of the silver nano-disk is preferably less than or equal to 20 nm, is more preferably 2 to 15 nm, and is particularly preferably 4 to 12 nm.

The particle thickness T corresponds to a distance between the main planes of the silver nano-disk, and for example, is illustrated in FIG. 5 and FIG. 6. The particle thickness T is able to be measured by an atomic force microscope (AFM) or a transmission type electron microscope (TEM).

Examples of a measurement method of the average particle thickness using AFM include a method in which a particle dispersion liquid containing a silver nano-disk is dropped onto a glass substrate and is dried, and a thickness per one particle is measured, and the like.

Examples of a measurement method of the average particle thickness using TEM include a method in which a particle dispersion liquid containing a silver nano-disk is dropped onto a silicon substrate and is dried, and then, a coating treatment is performed by carbon vapor deposition and metal vapor deposition, a sectional segment is prepared by focused ion beam (FIB) processing, and the sectional surface is observed by TEM, and thus, the thickness of the particle is measured, and the like.

In the present invention, a ratio D/T (the aspect ratio) of the diameter D of the silver nano-disks 42 (the average equivalent circle diameter) to the average thickness T is not particularly limited insofar as the ratio D/T is greater than or equal to 3, and is able to be suitably selected according to the purpose, and the ratio D/T is preferably 3 to 40, and is more preferably 5 to 40, from the viewpoint of reducing absorption of a visible light ray and a haze. In a case where the aspect ratio is greater than or equal to 3, it is possible to suppress the absorption of the visible light ray, and in a case where the aspect ratio is less than 40, it is also possible to suppress a haze in a visible range.

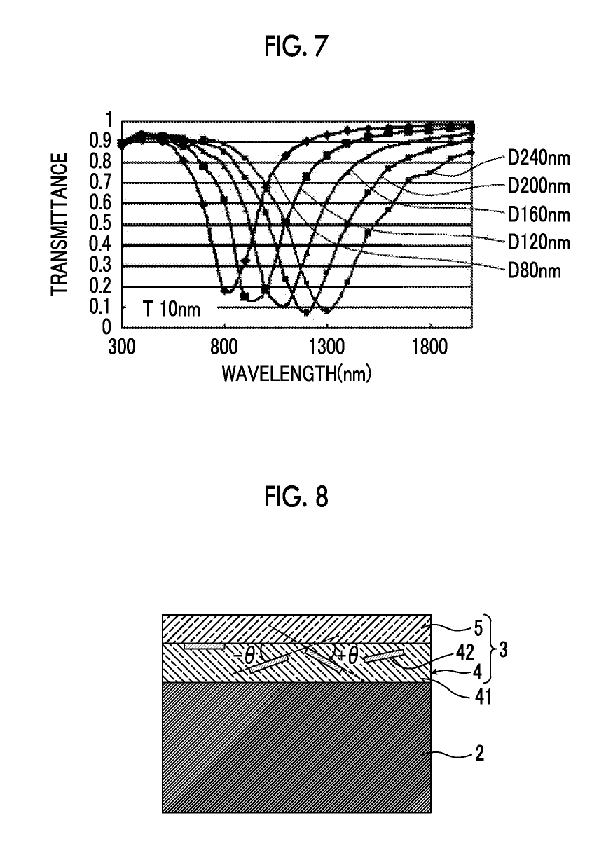

A simulation result of wavelength dependency of a transmittance in a case where an aspect ratio of circular metal particles is changed is illustrated in FIG. 7. In the circular metal particles, a case is considered in which the thickness T is set to 10 nm, and the diameter D is changed to 80 nm, 120 nm, 160 nm, 200 nm, and 240 nm. As illustrated in FIG. 7, an absorption peak (the bottom of the transmittance) is shifted to a long wavelength side as the aspect ratio increases, and the absorption peak is shifted to a short wavelength side as the aspect ratio decreases. In a case where the aspect ratio is less than 3, the absorption peak is close to a visible range, and thus, in a case where the aspect ratio is 1, the absorption peak is in the visible range. Thus, in a case where the aspect ratio is greater than or equal to 3, it is possible to improve a transmittance with respect to visible light. In particular, it is preferable that the aspect ratio is greater than or equal to 5.

[Plane Alignment]

In the silver nano-disk layer 4, a main surface of the silver nano-disk is subjected to plane alignment in a range of 0° to 30° with respect to the surface of the silver nano-disk layer 4. That is, in FIG. 8, an angle (±θ) between the surface of the silver nano-disk layer 4 and the main plane of the silver nano-disks 42 (a surface determining the equivalent circle diameter D) or an extended line of the main plane is 0° to 30°. It is more preferable that the plane alignment is performed in a range where the angle (±θ) is 0° to 20°, and it is particularly preferable that the plane alignment is performed in a range where the angle (±θ) is 0° to 10°. When the sectional surface of the antireflection film is observed, it is more preferable that the silver nano-disks 42 are aligned in a state where an inclination angle (±θ) illustrated in FIG. 8 is small. In a case where θ is greater than ±30°, there is a concern in which the absorption of the visible light ray in the antireflection film increases.

In addition, the number of silver nano-disks subjected to the plane alignment in a range where the angle θ is 0° to ±30° described above is preferably greater than or equal to 50%, is more preferably greater than or equal to 70% of the total number of silver nano-disks, and is even more preferably greater than or equal to 90%, with respect to the total number of silver nano-disks.

In evaluation of whether or not the main plane of the silver nano-disks is subjected to the plane alignment with respect to one surface of the silver nano-disk layer, for example, it is possible to adopt a method in which a suitable sectional segment is prepared, a silver nano-disk layer and a silver nano-disk in the segment are observed and evaluated. Specifically, examples of an evaluation method include a method in which a sectional surface sample or a sectional segment sample of the antireflection film is prepared by using a microtome and a focused ion beam (FIB), and evaluation is performed from an image obtained by observing the sample by using various microscopes (for example, a field-emission-type scanning electron microscope (FE-SEM), a transmission type electron microscope (TEM), and the like), and the like.

An observation method of the sectional surface sample or the sectional segment sample prepared as described above is not particularly limited insofar as whether or not the main plane of the silver nano-disk is subjected to the plane alignment with respect to one surface of the silver nano-disk layer in the sample is able to be confirmed, and examples of the observation method include a method using FE-SEM, TEM, and the like. In a case of the sectional surface sample, the observation may be performed by FE-SEM, and in a case of the sectional segment sample, the observation may be performed by TEM. In a case where the evaluation is performed by FE-SEM, it is preferable that the shape of the silver nano-disk and an inclination angle (±θ of FIG. 8) have obviously determinable spatial resolving power.

[Thickness of Silver Nano-Disk Layer and Presence Range of Silver Nano-Disk]

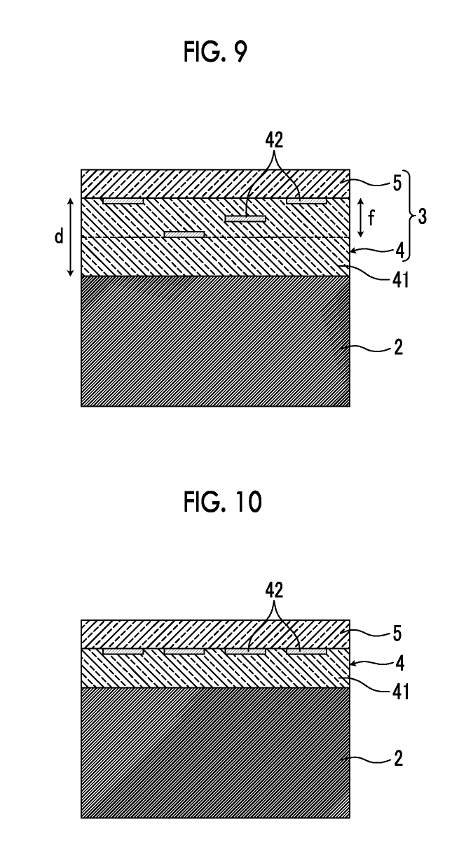

FIG. 9 and FIG. 10 are schematic sectional views illustrating a presence state of the silver nano-disks 42 in the silver nano-disk layer 4.

Since an angle range of the plane alignment of the silver nano-disk is close to 0° as a coated film thickness of the silver nano-disk layer 4 is smaller than a coating thickness, and thus, the absorption of the visible light ray is able to be reduced, the coated film thickness is preferably less than or equal to 100 nm, is more preferably 3 to 50 nm, and is particularly preferably 5 to 40 nm.

In a case where the coated film thickness d of the silver nano-disk layer 4 with respect to the average equivalent circle diameter D of the silver nano-disks is d>D/2, it is preferable that greater than or equal to 80 number % of the silver nano-disks 42 is present in a range of d/2 from the surface of the silver nano-disk layer 4, it is more preferable that greater than or equal to 80 number % of the silver nano-disks 42 is present in a range of d/3 from the surface of the silver nano-disk layer 4, it is even more preferable that greater than or equal to 60 number % of the silver nano-disks is exposed to one surface of the silver nano-disk layer. The silver nano-disk being present in a range of d/2 from the surface of the silver nano-disk layer indicates that at least a part of the silver nano-disks is included in a range of d/2 from the surface of the silver nano-disk layer. FIG. 9 is a schematic view illustrating a case where the thickness d of the silver nano-disk layer is d>D/2, and in particular, illustrating that greater than or equal to 80 number % of the silver nano-disks is included in a range of f, and f<d/2.

In addition, the silver nano-disk being exposed to one surface of the silver nano-disk layer indicates that a part of one surface of the silver nano-disk is in an interface position with respect to the layer of low refractive index. FIG. 10 is a diagram illustrating a case where one surface of the silver nano-disk is coincident with the interface with respect to the layer of low refractive index.

Here, a silver nano-disk presence distribution in the silver nano-disk layer, for example, is able to be measured by an image obtained by performing SEM observation with respect to the sectional surface of the antireflection film.

Furthermore, the coated film thickness d of the silver nano-disk layer with respect to the average equivalent circle diameter D of silver nano-disks is preferably d<D/2, is more preferably d<D/4, and is even more preferably d<D/8. It is preferable that the coated film thickness of the silver nano-disk layer decreases since the angle range of the plane alignment of the silver nano-disks is close to 0°, and thus, the absorption of the visible light ray is able to be reduced.

A plasmon resonance wavelength (an absorption peak wavelength in FIG. 7) of the silver nano-disk in the silver nano-disk layer is not limited insofar as the wavelength is longer than a wavelength to be prevented from being reflected, and is able to be suitably selected according to the purpose, but in order to shield a heat ray, it is preferable that the plasmon resonance wavelength is 700 nm to 2,500 nm.

[Area Ratio of Silver Nano-Disk]

It is preferable that an area ratio [(B/A)×100] which is a ratio of a total value B of the area of the silver nano-disks to a total projection area A in the silver nano-disk layer at the time of being seen from a vertical direction with respect to the silver nano-disk layer is from 5% to 40%. The conditions in which the aspect ratio of the silver nano-disk described above is greater than or equal to 3 are satisfied, and the area ratio is set to be from 5% to 40%, and thus, the reflectivity from the front surface and the reflectivity from the back surface in the antireflection structure are changed, and different reflectivity on the front surface and the back surface is able to be obtained.

Here, the area ratio, for example, is able to be measured by an performing an image treatment with respect to an image which is obtained by performing SEM observation from an upper portion of the antireflection film or an image which is obtained by atomic force microscope (AFM) observation.

[Arrangement of Silver Nano-Disks]

It is preferable that the arrangement of the silver nano-disks in the silver nano-disk layer is even. Here, the evenness of the arrangement indicates that when a distance to the closest particles with respect to each particle (a distance between the closest particles) is digitized by a distance between the centers of the particles, a coefficient of variation of the distance between the closest particles of each particle (=Standard Deviation÷ Average Value) is small. It is preferable that the coefficient of variation of the distance between the closest particles decreases, and the coefficient of variation is preferably less than or equal to 30%, is more preferably less than or equal to 20%, and is even more preferably less than or equal to 10%, and is ideally 0%. It is not preferable that the coefficient of variation of the distance between the closest particles is large since the silver nano-disks become crude or aggregation between the particles occurs in the silver nano-disk layer, and thus, the haze tends to deteriorate. The distance between the closest particles is able to be measured by observing the coated surface of the silver nano-disk layer with SEM or the like.

In addition, a boundary between the silver nano-disk layer and the layer of low refractive index is able to be determined by being similarly observed with SEM or the like, and the thickness d of the silver nano-disk layer is able to be determined. Furthermore, even in a case where the layer of low refractive index is formed on the silver nano-disk layer by using the same type binder as the binder included in the silver nano-disk layer, in general, the boundary with respect to the silver nano-disk layer is able to be determined according to an image which has been subjected to SEM observation, and the thickness d of the silver nano-disk layer is able to be determined. Furthermore, in a case where the boundary is not obvious, the surface of flat plate metal in a position which is most separated from the substrate is assumed as the boundary.

[Synthesis Method of Silver Nano-Disk]

A synthesis method of the silver nano-disk is not particularly limited, and is able to be suitably selected according to the purpose, and examples of a method of synthesizing silver nano-disks having a hexagonal shape to a circular shape include a liquid phase method such as a chemical reduction method, a photochemical reduction method, and an electrochemical reduction method, and the like. Among them, a liquid phase method such as the chemical reduction method and the photochemical reduction method is particularly preferable from the viewpoint of controlling the shape and the size. Silver nano-disks having a hexagonal shape to a triangular shape may be synthesized, and then, for example, an etching treatment of dissolution species such as a nitric acid and sodium sulfite which dissolve silver, an aging treatment due to heating, and the like may be performed, and thus, the angle of the silver nano-disks having a hexagonal shape to a triangular shape may become a blunt angle, and silver nano-disks having a hexagonal shape to a circular shape may be obtained.

In addition, in the synthesis method of the silver nano-disk, seed crystals may be fixed onto the surface of a transparent substrate such as a film and glass in advance, and then, silver may be subjected to crystalline growth on a flat plate.

In the antireflection film of the present invention, in order to applying desirable properties, the silver nano-disk may be subjected to an additional treatment. Examples of the additional treatment include forming a shell layer of high refractive index and adding various additives such as a dispersant and an antioxidant.

—Binder—

The binder 41 in the silver nano-disk layer 4 preferably contains a polymer, and more preferably contains a transparent polymer. Examples of the polymer include a polymer such as a polyvinyl acetal resin, a polyvinyl alcohol resin, a polyvinyl butyral resin, a polyacrylate resin, a polymethyl methacrylate resin, a polycarbonate resin, a polyvinyl chloride resin, a (saturated) polyester resin, a polyurethane resin, and natural polymer such as gelatin or cellulose. Among them, a polymer is preferable in which a main polymer is a polyvinyl alcohol resin, a polyvinyl butyral resin, a polyvinyl chloride resin, a (saturated) polyester resin, and a polyurethane resin, and a polymer is more preferable in which the main polymer is a polyester resin and a polyurethane resin, from the viewpoint of allowing greater than or equal to 80 number % of the silver nano-disks to be easily present in a range of d/2 from the surface of the silver nano-disk layer.

Two or more types of binders may be used in combination.

Among the polyester resins, the saturated polyester resin does not have a double bond, and thus, is particularly preferable from the viewpoint of applying excellent weather fastness. In addition, a polyester resin having a hydroxyl group or a carboxyl group in a molecular terminal is more preferable from the viewpoint of obtaining high hardness, high durability, and high heat resistance by being cured with a water-soluble and water dispersible curing agent or the like.

A commercially available polymer is able to be preferably used as the polymer, and examples of the commercially available polymer include PLASCOAT Z-687 manufactured by GOO CHEMICAL CO., LTD., which is a water-soluble polyester resin, and the like.

In addition, herein, the main polymer contained in the silver nano-disk layer indicates a polymer component occupying greater than or equal to 50 mass % of the polymer contained in the silver nano-disk layer.

A content of a polyester resin and a polyurethane resin to the silver nano-disks contained in the silver nano-disk layer is preferably 1 to 10,000 mass %, is more preferably 10 to 1,000 mass %, and is particularly preferably 20 to 500 mass %.

It is preferable that a refractive index n of the binder is 1.4 to 1.7.

<Layer of Low Refractive Index>

The thickness of the layer of low refractive index 5 is a thickness in which reflection light L_{R1} of an incidence ray from the surface of the layer of low refractive index 5 in the layer of low refractive index 5 is cancelled by being interfered with reflection light L_{R2} of an incidence ray L in the silver nano-disk layer 4. Here, the reflection light L_{R1} being cancelled by being interfered with the reflection light L_{R2} of the incidence ray L in the silver nano-disk layer 4″ indicates that the reflection light L_{R1} and the reflection light L_{R2} are interfered with each other, and the entire reflected light is reduced, but is not limited to a case where the reflected light is completely removed.

Specifically, it is preferable that the thickness of the layer of low refractive index 5 is less than or equal to 400 nm, and it is more preferable that the thickness is a thickness in which the optical path length with respect to an incidence ray wavelength λ is less than or equal to λ/4.

In principle, the optical path length of λ/8 is optimal as the thickness of the layer of low refractive index 5, and the optimal value is changed in a range of approximately λ/16 to λ/4 according to the conditions of the silver nano-disk layer, and thus, may be suitably set according to a layer configuration.

A configuration material of the layer of low refractive index 5 is not particularly limited insofar as the layer of low refractive index 5 has a refractive index smaller than the refractive index of the transparent substrate 2.

The layer of low refractive index, for example, is a layer formed by curing a composition containing a thermoplastic polymer, a thermosetting polymer, an energy radiation curable polymer, an energy radiation curable monomer, and the like as a binder with thermal dry or irradiation of energy radiation, and examples of the layer of low refractive index are able to include a layer in which low refractive index particles having a low refractive index are dispersed in a binder, a layer formed by polycondensing or cross-linking low refractive index particles having a low refractive index along with a monomer and a polymerization initiator, a layer containing a binder having a low refractive index, and the like.

Examples of the energy radiation curable polymer are not particularly limited, and include UNIDIC EKS-675 (an ultraviolet curable resin manufactured by DIC Corporation), and the like. The energy radiation curable monomer is not particularly limited, but a fluorine-containing polyfunctional monomer described below, and the like are preferable.

(Fluorine-Containing Polyfunctional Monomer)

A fluorine-containing polyfunctional monomer may be contained in the composition used at the time of disposing the layer of low refractive index. The fluorine-containing polyfunctional monomer is a fluorine-containing compound having an atomic group which is mainly formed of a plurality of fluorine atoms and carbon atoms (here, may contain an oxygen atom and/or a hydrogen atom in a part thereof) and does not substantially affect polymerization (hereinafter, also referred to as a “fluorine-containing core portion”) and three or more polymerizable groups which have polymerizability such as radical polymerizability, cationic polymerizability, or condensation polymerizability through a linking group such as an ester bond or an ether bond, and the fluorine-containing polyfunctional monomer preferably has five or more polymerizable groups, and more preferably has six or more polymerizable groups.

Further, the fluorine content in the fluorine-containing polyfunctional monomer is preferably greater than or equal to 35 mass % of the fluorine-containing polyfunctional monomer, and is more preferably greater than or equal to 40 mass % of the fluorine-containing polyfunctional monomer, and is even more preferably greater than or equal to 45 mass % of the fluorine-containing polyfunctional monomer. It is preferable that the fluorine content in the fluorine compound is greater than or equal to 35 mass % since it is possible to decrease the refractive index of the polymer and to decrease the average reflectivity of the coated film.

The fluorine-containing polyfunctional monomer having three or more polymerizable groups may be a cross-linking agent having a polymerizable group as a cross-linkable group.

Two or more types of the fluorine-containing polyfunctional monomers may also be used in combination.

Hereinafter, a preferred specific example of the fluorine-containing polyfunctional monomer will be described, but the present invention is not limited thereto.

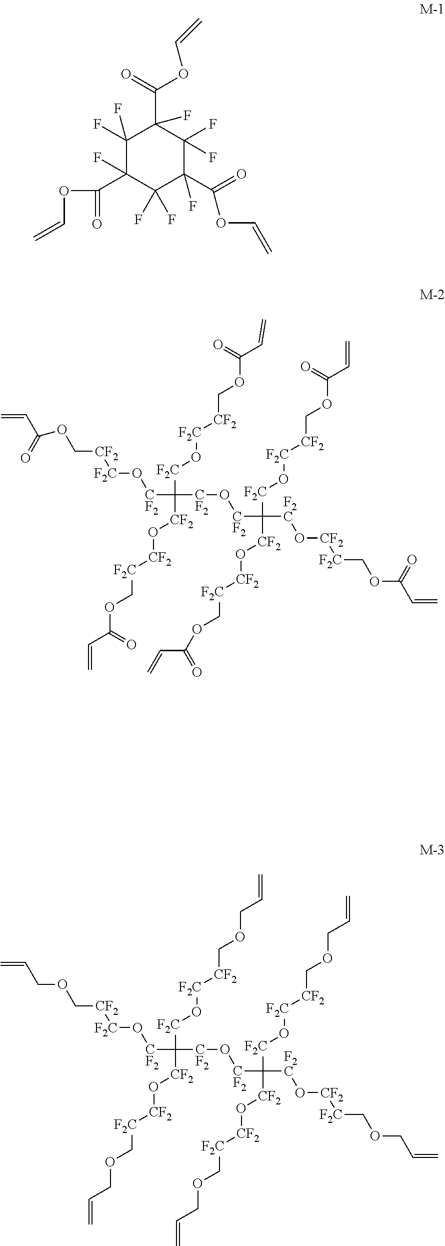

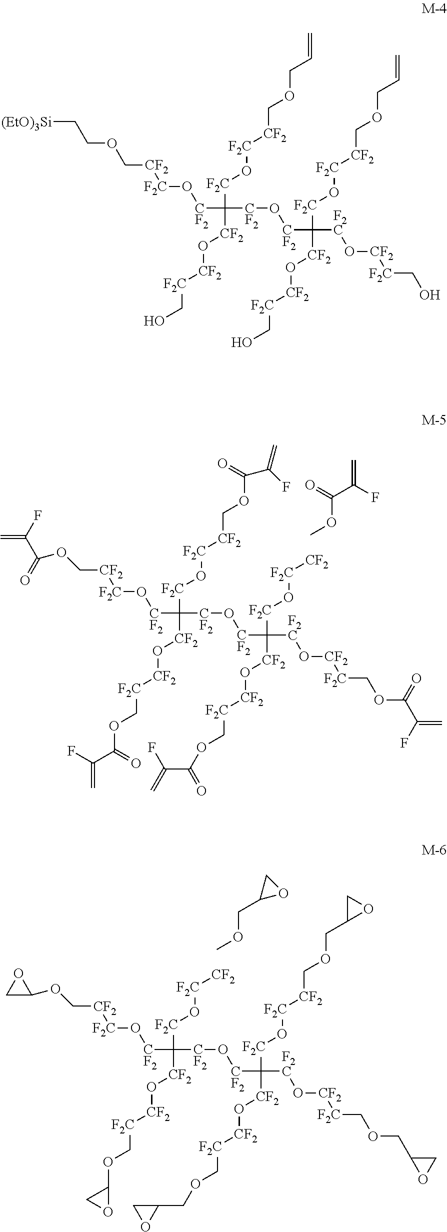

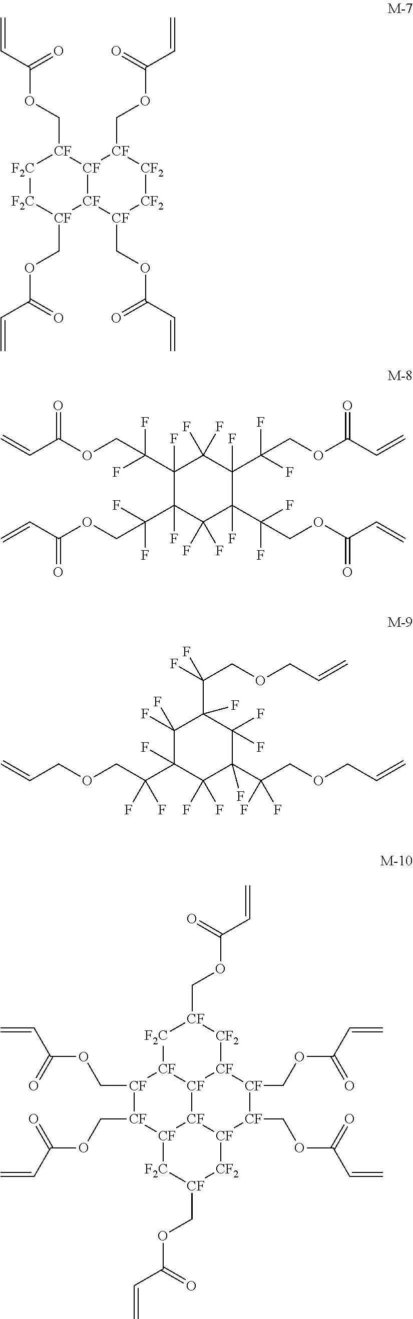

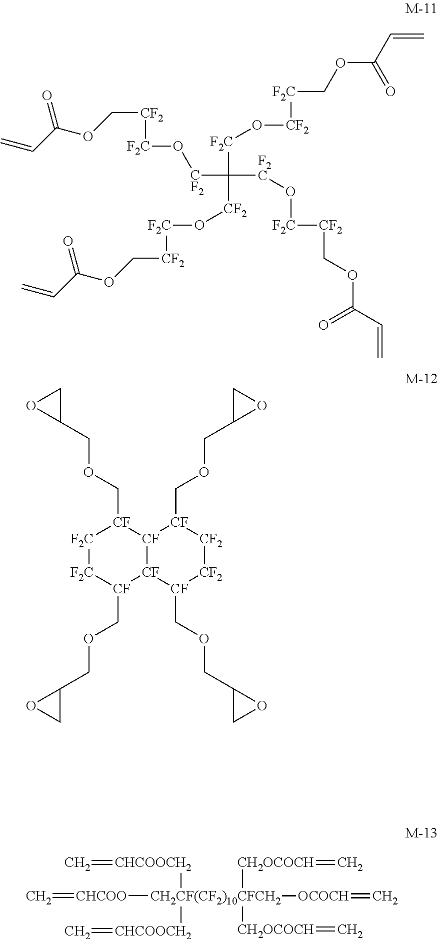

Fluorine content rates of M-1 to M-13 are 37.5, 46.2, 48.6, 47.7, 49.8, 45.8, 36.6, 39.8, 44.0, 35.1, 44.9, 36.2, and 39.0 mass %, respectively.

(Fluorine-Containing Polymer)

The fluorine-containing polyfunctional monomer is polymerized by various polymerization methods, and is able to be used as a fluorine-containing polymer (polymer). When the polymerization is performed, the polymerization may also be homopolymerization or copolymerization, and the fluorine-containing polymer may also be used as a cross-linking agent.

The fluorine-containing polymer may also be synthesized from a plurality of monomers. Two or more types of the fluorine-containing polymers may also be used in combination.

Examples of a solvent to be used include ethyl acetate, butyl acetate, acetone, methyl ethyl ketone, methyl isobutyl ketone, cyclohexanone, tetrahydrofuran, dioxane, N,N-dimethyl formamide, N,N-dimethyl acetamide, benzene, toluene, acetonitrile, methylene chloride, chloroform, dichloroethane, methanol, ethanol, 1-propanol, 2-propanol, 1-butanol, and the like. Only one type thereof may be independently used or two or more types thereof may be used by being mixed.

Both an initiator generating radicals by an action of heat and an initiator generating radicals by an action of light is able to be used as an initiator of the radical polymerization.

An organic peroxide or an inorganic peroxide, an organic azo compound, a diazo compound, and the like are able to be used as a compound initiating the radical polymerization by the action of heat.

Specifically, examples of the organic peroxide are able to include benzoyl peroxide, halogen benzoyl peroxide, lauroyl peroxide, acetyl peroxide, dibutyl peroxide, cumene hydroperoxide, and butyl hydroperoxide, examples of the inorganic peroxide are able to include hydrogen peroxide, ammonium persulfate, potassium persulfate, and the like, examples of the organic azo compound are able to include 2-azo-bis-isobutyronitrile, 2-azo-bis-propionitrile, 2-azo-bis-cyclohexane dinitrile, and the like, and examples of the diazo compound are able to include diazo aminobenzene, p-nitrobenzene diazonium, and the like.

In a case where a compound initiating the radical polymerization by the action of light (a photoradical polymerization initiator) is used, a film is subjected to curing by irradiation with an active energy ray.

Examples of such a photoradical polymerization initiator include acetophenones, benzoins, benzophenones, phosphine oxides, ketals, anthraquinones, thioxanthones, an azo compound, peroxides, 2,3-dialkyl dione compounds, disulfide compounds, fluoroamine compounds, aromatic sulfoniums, and the like. Examples of the acetophenones include 2,2-diethoxy acetophenone, p-dimethyl acetophenone, 1-hydroxy dimethyl phenyl ketone, 1-hydroxy cyclohexyl phenyl ketone, 2-methyl-4-methyl thio-2-morpholinopropiophenone, and 2-benzyl-2-dimethyl amino-1-(4-morpholinophenyl)-butanone. Examples of the benzoins include benzoin benzene sulfonic acid ester, benzoin toluene sulfonic acid ester, benzoin methyl ether, benzoin ethyl ether, and benzoin isopropyl ether. Examples of the benzophenones include benzophenone, 2,4-dichlorobenzophenone, 4,4-dichlorobenzophenone, and p-chlorobenzophenone. Examples of the phosphine oxides include 2,4,6-trimethyl benzoyl diphenyl phosphine oxide. A sensitizing dye is also able to be used in combination with such photoradical polymerization initiators.

The added amount of the radical polymerization initiator is not particularly limited insofar as a radical reactive group is able to initiate a polymerization reaction, and in general, the added amount is preferably 0.1 to 15 mass %, is more preferably 0.5 to 10 mass %, and is particularly preferably 2 to 5 mass %, with respect to the total solid content in a curable resin composition.

Two or more types of the radical polymerization initiators may be used in combination. In this case, it is preferable that the total amount of the radical polymerization initiators is in the range described above.

A polymerization temperature is not particularly limited, and may be suitably adjusted according to the type of initiator. In addition, in a case where the photoradical polymerization initiator is used, in particular, heating is not necessary, but heating may be performed.

The curable resin composition forming the fluorine-containing polymer is able to contain various additives in addition to the additives described above, from the viewpoint of film hardness, a refractive index, antifouling properties, water resistance, chemical resistance, and smoothness.

For example, inorganic oxide fine particles such as (hollow) silica, a silicone-based antifouling agent or a fluorine-based antifouling agent, a lubricant, and the like are able to be added. In a case where such additives are added, the added amount is preferably in a range of 0 to 30 mass %, is more preferably in a range of 0 to 20 mass %, and is particularly preferably in a range of 0 to 10 mass %, with respect to the total solid content of the curable resin composition.

<Layer of High Refractive Index>

The refractive index of the layer of high refractive index 6 may be greater than the refractive index of the transparent substrate, is preferably greater than or equal to 1.55, and is particularly preferably greater than or equal to 1.6.

A configuration material of the layer of high refractive index 6 is not particularly limited insofar as the refractive index is greater than 1.55. For example, the layer of high refractive index 6 contains a binder, metal oxide fine particles, a matting agent, and a surfactant, and as necessary, contains other components. The binder is not particularly limited, and is able to be suitably selected according to the purpose, and examples of the binder include a thermosetting resin or a photocurable resin such as an acrylic resin, a silicone-based resin, a melamine-based resin, a urethane-based resin, an alkyd-based resin, and a fluorine-based resin, and the like.

The material of the metal oxide fine particles is not particularly limited insofar as metal fine particles having a refractive index larger than the refractive index of the binder are used, and is able to be suitably selected according to the purpose, and examples of material of the metal oxide fine particles include tin-doped indium oxide (hereinafter, simply referred to as “ITO”), zinc oxide, titanium oxide, zirconium oxide, and the like.

[Hard Coat Layer]

It is preferable that the hard coat layer 7 having hard coat properties is included in order to apply abrasion resistance. The hard coat layer 7 is able to contain metal oxide particles or an ultraviolet absorbent.

The hard coat layer 7 is not particularly limited, and the type and the formation method thereof are able to be suitably selected according to the purpose, and examples of the material of the hard coat layer 7 include a thermosetting resin or a photocurable resin such as an acrylic resin, a silicone-based resin, a melamine-based resin, a urethane-based resin, an alkyd-based resin, and a fluorine-based resin, and the like. The thickness of the hard coat layer 7 is not particularly limited, and is able to be suitably selected according to the purpose, and it is preferable that the thickness of the hard coat layer 7 is 1 μm to 50 μm.

[Pressure Sensitive Adhesive Layer]

As described above, in a case where the antireflection film adheres onto the glass plate, the pressure sensitive adhesive layer 9 is formed on the back surface of the transparent substrate 2 of the antireflection film.

The pressure sensitive adhesive layer is able to contain an ultraviolet absorbent.

A material which is able to be used for forming the pressure sensitive adhesive layer is not particularly limited, and is able to be suitably selected according to the purpose, and examples of the material include a polyvinyl butyral (PVB) resin, an acrylic resin, a styrene/acrylic resin, a urethane resin, a polyester resin, a silicone resin, and the like. Only one type thereof may be independently used, or two or more types thereof may be used in combination. The pressure sensitive adhesive layer formed of such materials is able to be formed by coating or lamination.

Further, an antistatic agent, a lubricant, an antiblocking agent, and the like may be added to the pressure sensitive adhesive layer.

It is preferable that the thickness of the pressure sensitive adhesive layer is 0.1 μm to 10 μm.

<Other Layers and Components>

The antireflection film of the present invention may include layers other than each of the layers described above. For example, the antireflection film of the present invention may include an infrared ray absorbing compound-containing layer, a ultraviolet absorbent-containing layer, and the like.

[Ultraviolet Absorbent]

It is preferable that the antireflection film of the present invention includes a layer containing an ultraviolet absorbent.

The layer containing the ultraviolet absorbent is able to be suitably selected according to the purpose, and may be the pressure sensitive adhesive layer or may be a layer between the pressure sensitive adhesive layer and the silver nano-disk layer. In both cases, it is preferable that the ultraviolet absorbent is added to a layer arranged on a side to which solar light is emitted, with respect to the silver nano-disk layer.

[Metal Oxide Particles]

The antireflection film of the present invention may contain at least one type of metal oxide particles in order to shield a heat ray.

A material of the metal oxide particles is not particularly limited, is able to be suitably selected according to the purpose, and examples of the material include tin-doped indium oxide (hereinafter, simply referred to as “ITO”), antimony-doped tin oxide (hereinafter, simply referred to as “ATO”), zinc oxide, zinc antimonate, titanium oxide, indium oxide, tin oxide, antimony oxide, glass ceramics, lanthanum hexaboride (LaB₆), cesium tungsten oxide (Cs_{0.33}WO₃, hereinafter, simply referred to as “CWO”), and the like. Among them, ITO, ATO, CWO, and lanthanum hexaboride (LaB₆) are more preferable from the viewpoint of excellent heat ray absorptive power and of manufacturing an antireflection structure having wide heat ray absorptive power by being combined with the silver nano-disk, and ITO is particularly preferable from the viewpoint of shielding greater than or equal to 90% of an infrared ray of greater than or equal to 1,200 nm and of a visible light transmittance of greater than or equal to 90%.

It is preferable that a volume average particle diameter of primary particles of the metal oxide particles is less than or equal to 0.1 μm in order not to decrease a visible light transmittance.

The shape of the metal oxide particles is not particularly limited, is able to be suitably selected according to the purpose, and examples of the shape of the metal oxide particles include a spherical shape, a needle shape, a plate shape, and the like.

Next, a formation method of each layer will be described.

—Formation Method of Silver Nano-Disk Layer—

A formation method of the silver nano-disk layer 4 is not particularly limited. Examples of the formation method of the silver nano-disk layer 4 include a method of applying a dispersion liquid containing the silver nano-disks (a silver nano-disk dispersion liquid) onto the surface of the transparent substrate by a dip coater, a die coater, a slit coater, a bar coater, a gravure coater, and the like, an LB film method, a self-organization method, and a method of performing plane alignment using a method such as spray coating.

Furthermore, in order to accelerate the plane alignment, the silver nano-disk layer 4 may pass through a pressure bonding roller such as a calendar roller or a laminating roller, after applying the silver nano-disks.

—Formation Method of Layer of Low Refractive Index—

It is preferable that the layer of low refractive index 5 is formed by coating. At this time, the coating method is not particularly limited, and a known method is able to be used, and examples of the coating method of the layer of low refractive index 5 include a method of applying a dispersion liquid containing an ultraviolet absorbent by a dip coater, a die coater, a slit coater, a bar coater, a gravure coater, and the like, and the like.

—Formation Method of Hard Coat Layer—

It is preferable that the hard coat layer 7 is formed by coating. At this time, the coating method is not particularly limited, a known method is able to be used, and examples of the coating method of the hard coat layer 7 include a method of applying a dispersion liquid containing an ultraviolet absorbent by a dip coater, a die coater, a slit coater, a bar coater, a gravure coater, and the like, and the like.

—Formation Method of Pressure Sensitive Adhesive Layer—

It is preferable that the pressure sensitive adhesive layer is formed by coating. For example, the pressure sensitive adhesive layer is able to be laminated on the surface of an underlayer such as a substrate, a silver nano-disk layer, and an ultraviolet ray absorption layer. At this time, the coating method is not particularly limited, and a known method is able to be used.

A film is prepared in which a pressure sensitive adhesive is applied onto a peeling film and is dried in advance, the pressure sensitive adhesive surface of the film is laminated on the surface of the antireflection structure of the present invention, and thus, the pressure sensitive adhesive layer is able to be laminated in a dry state. At this time, a lamination method thereof is not particularly limited, and a known method is able to be used.

[Preparation Method of Functional Glass]

In a case where functionality is applied to window glasses by using the antireflection film of the present invention, it is preferable that the pressure sensitive adhesive is laminated and adheres onto the surface of the window glass on the indoor side or both surfaces of the window glass. When the antireflection film adheres to the window glass, the antireflection film may be prepared in which the pressure sensitive adhesive layer is disposed by coating or lamination, an aqueous solution containing a surfactant (mainly an anionic surfactant) may be sprayed onto the surface of the window glass and the pressure sensitive adhesive layer surface of the antireflection film in advance, and then, the antireflection film may be disposed on the window glass through the pressure sensitive adhesive layer. The pressure sensitive adhesive force of the pressure sensitive adhesive layer is low until moisture is evaporated, and thus, the position of the antireflection structure on the glass surface is able to be adjusted. The adhesion position of the antireflection structure with respect to the window glass is determined, and then, moisture remaining between the window glass and the antireflection film is swept away from the center of the glass towards an end portion by using a squeegee or the like, and thus, the antireflection film is able to be fixed onto the surface of the window glass. Thus, the antireflection film is able to be disposed on the window glass.

Applying functionality to the window glass is attained by a method such as heat or pressure lamination in which the antireflection film of the present invention mechanically adheres onto the glass plate by using laminator equipment. A laminator is prepared in which the glass plate passes through a slit area interposed between a heated metal roll or a rubber roll having heat resistance from an upper portion and a rubber roll having heat resistance which is at room temperature or is heated from a lower portion. The film is placed on the glass plate such that the pressure sensitive adhesive surface is in contact with the glass surface, and the upper portion roll of the laminator is set to press the film, and thus, the glass plate passes through the laminator. In a case where the adhesion is performed by selecting a suitable roll heating temperature according to the type of pressure sensitive adhesive, the pressure sensitive adhesive force becomes strong, and thus, the adhesion is able to be performed such that air bubbles are not mixed thereinto. In a case where the film is able to be supplied in the shape of a roll, a tapered film is continuously supplied to a heating roll from the upper portion, and the heating roll is set to have a warp angle of approximately 90 degrees, and thus, the pressure sensitive adhesive layer of the film is preheated and is easily subjected to the adhesion, and both of elimination of the air bubbles and an improvement in the pressure sensitive adhesive force are able to be high dimensionally attained.

### EXAMPLES

Hereinafter, examples and comparative examples of the present invention will be described.

First, preparation and evaluation of various coating liquids used for preparing an antireflection film of Example 1 will be described.

—Preparation of Silver Nano-Disk Dispersion Liquid A—

13 L of ion exchange water was measured in a reaction container of NTKR-4 (manufactured by Nippon Metal Industry Co., Ltd.), and 1.0 L of an aqueous solution of trisodium citrate (an anhydride) of 10 g/L was added and retained at 35° C. while being stirred by using a chamber including an agitator in which four propellers of NTKR-4 and four paddles of NTKR-4 were attached to a shaft of SUS316L. 0.68 L of an aqueous solution of a polystyrene sulfonic acid of 8.0 g/L was added, and 0.041 L of an aqueous solution of sodium boron hydride which was prepared to be 23 g/L was further added by using an aqueous solution of sodium hydroxide of 0.04 N. 13 L of an aqueous solution of silver nitrate of 0.10 g/L was added at 5.0 L/min.

1.0 L of an aqueous solution of trisodium citrate (an anhydride) of 10 g/L and 11 L of ion exchange water were added, and 0.68 L of an aqueous solution of potassium hydroquinone sulfonate of 80 g/L was further added. Stirring was performed at 800 rpm, and 8.1 L of an aqueous solution of silver nitrate of 0.10 g/L was added at 0.95 L/min, and then, and the temperature was lowered to 30° C.

8.0 L of an aqueous solution of methyl hydroquinone of 44 g/L was added, and then, the total amount of a gelatin aqueous solution at 40° C. described below was added. Stirring was performed at 1,200 rpm, and the total amount of a mixed liquid of a white precipitate of silver sulfite described below was added.

In a step where a pH change in the prepared liquid stopped, 5.0 L of an aqueous solution of NaOH of 1 N was added at 0.33 L/min. After that, 0.18 L of an aqueous solution of sodium 1-(m-sulfophenyl)-5-mercaptotetrazole of 2.0 g/L (dissolved by adjusting pH to be 7.0±1.0 with NaOH and a citric acid (an anhydride)) was added, and 0.078 L of an aqueous solution of 1,2-benzisothiazolin-3-one (dissolved by adjusting the aqueous solution to be alkaline with NaOH) of 70 g/L was further added. Thus, a silver nano-disk dispersion liquid A was prepared.

—Preparation of Gelatin Aqueous Solution—

16.7 L of ion exchange water was measured in a dissolving tank of SUS316L. 1.4 kg of alkali-treated osgoniale gelatin (GPC weight-average molecular weight of 200,000) which had been subjected to a deionization treatment was added while being stirred at a low speed in an agitator of SUS316L. Further, 0.91 kg of alkali-treated osgoniale gelatin (GPC weight-average molecular weight of 21,000) which has been subjected to a deionization treatment, a protein enzyme treatment, and an oxidation treatment of peroxide hydrogen was added. After that, the temperature rose to 40° C., the gelatin was simultaneously swelled and dissolved, and thus, the gelatin was completely dissolved.

—Preparation of Mixed Liquid of White Precipitate of Silver Sulfite—

8.2 L of ion exchange water was measured in a dissolving tank of SUS316L, and 8.2 L of an aqueous solution of silver nitrate of 100 g/L was added. 2.7 L of an aqueous solution of sodium sulfite of 140 g/L was added for a short period of time while being stirred at a high speed in an agitator of SUS316L, and thus, a mixed liquid including a white precipitate of the silver sulfite was prepared. The mixed liquid was prepared immediately before being used.

—Preparation of Silver Nano-Disk Dispersion Liquid B—

800 g of the silver nano-disk dispersion liquid A described above was sampled into a centrifuge tube, and pH was adjusted to be 9.2±0.2 at 25° C. with NaOH of 1 N and/or a sulfuric acid of 1 N. The temperature was set to 35° C., and a centrifugal operation was performed at 9,000 rpm for 60 minutes by using a centrifugal separator (himacCR22GIII, an angle rotor R9A, manufactured by Hitachi Koki Co., Ltd.), and then, 784 g of a supernatant was removed. An aqueous solution of NaOH of 0.2 mM was added to the precipitated silver nano-disk such that the total amount thereof was set to 400 g, and stirring was manually performed by using a stirring rod, and thus, a coarse dispersion liquid was obtained. As with this operation, 24 coarse dispersion liquids were prepared such that the total amount was set to 9,600 g, and were added to a tank of SUS316L and mixed. Further, 10 cc of a solution of Pluronic31R1 (manufactured by BASF SE) of 10 g/L (diluted with a mixed liquid of Methanol:Ion Exchange Water=1:1 (a volume ratio)) was added. A batch type disperse treatment was performed with respect to the coarse dispersion liquid mixture in the tank at 9,000 rpm for 120 minutes by using a 20 type automixer (a stirring portion is a homomixer MARKII) manufactured by PRIMIX Corporation. A liquid temperature during the dispersion was retained at 50° C. After the dispersion, the temperature was lowered to 25° C., and then, single-pass filtration was performed by using a PROFILE II filter (manufactured by Pall Corporation, a product type of MCY1001Y030H13).

Thus, the dispersion liquid A was subjected to a dechlorination treatment and re-dispersion treatment, and thus, a silver nano-disk dispersion liquid B was prepared.

—Evaluation of Silver Nano-Disk—

It was confirmed that flat plate particles having a hexagonal shape to a circular shape and a triangular shape were generated in the silver nano-disk dispersion liquid A. An image obtained by TEM observation of the silver nano-disk dispersion liquid A was imported into image treatment software Image J, and an image treatment was performed. 500 particles arbitrarily extracted from TEM images in a plurality of visual fields were subjected to image analysis, and an equivalent circle diameter in the same area was calculated. As a result of performing statistic processing based on the parent population, the average diameter was 120 nm.

The silver nano-disk dispersion liquid B was similarly measured, and thus, approximately the same result as that of the silver nano-disk dispersion liquid A, which also included the shape of a particle size distribution, was obtained.

The silver nano-disk dispersion liquid B was dropped onto a silicon substrate and was dried, and the thickness of each of the silver nano-disks was measured by an FIB-TEM method. 10 silver nano-disks in the silver nano-disk dispersion liquid B were measured, and the average thickness was 8 nm.

—Preparation of Coating Liquid C for Silver Nano-Disk Layer—

A coating liquid C for a silver nano-disk layer was prepared at a composition in Table 1 described below.

The unit of each value is parts by mass.

TABLE 1

| | |
|---|---|
| Polyurethane Aqueous Solution: HYDRAN HW-350 | 0.27 |
| (manufactured by DIC Corporation, Concentration of | |
| Solid Contents of 30 Mass %) | |
| Surfactant A: F LIPAL 8780P (manufactured by Lion | 0.96 |
| Corporation, Concentration of Solid Contents of 1 | |
| Mass %) | |
| Surfactant B: NAROACTY-CL-95 (manufactured by | 1.19 |
| Sanyo Chemical Industries Ltd., Solid Contents of 1 | |
| Mass %) | |
| Surfactant C (Sodium = | 1 |
| 1.2-{Bis(3,3,4,4,5,5,6,6,6-Nonafluorohexyl Carbonyl)} | |
| Ethane Sulfonate (Solid Contents of 2 Mass %) | |
| Silver Nano-Disk Dispersion Liquid B | 13.1 |
| 1-(5-Methyl Ureidophenyl)-5-Mercaptotetrazole | 0.61 |
| (manufactured by Wako Pure Chemical Industries, Ltd., | |
| Solid Contents of 2 Mass %) | |
| Water | 52.87 |
| Methanol | 30 |

—Preparation of Coating Liquid D for Hard Coat Layer—

A coating liquid D for a hard coat layer was prepared at a composition in Table described below.

The unit of each value is parts by mass.

TABLE 2

| | |
|---|---|
| A-TMMT: Pentaerythritol Tetraacrylate (manufactured by | 52 |
| Shin-Nakamura Chemical Co., Ltd., Concentration of Solid | |
| Contents of 75 Mass %) | |
| AD-TMP: Ditrimethylol Propane Tetraacrylate (manufactured | 19.18 |
| by Shin-Nakamura Chemical Co., Ltd., Concentration of Solid | |
| Contents of 100 Mass %) | |
| Leveling Agent A Methyl Ethyl Ketone Solution: Compound Described below (Concentration of Solid Contents of 2 Mass %) 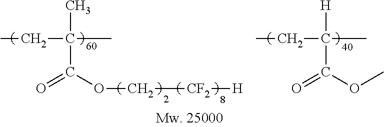 | 1.36 |
| Photopolymerization Initiator IRGACURE 127 (manufactured | 2.53 |
| by BASF SE) Concentration of Solid Contents of 100 Mass % | |
| Methyl Acetate | 10.61 |
| Methyl Ethyl Ketone | 14.31 |

—Preparation of Coating Liquid E of Layer of High Refractive Index—

A coating liquid E for a layer of high refractive index was prepared at a composition in Table described below. The unit of each value is parts by mass.

TABLE 3

| | |
|---|---|
| A-TMMT: Pentaerythritol Tetraacrylate (manufactured by | 1.8 |
| Shin-Nakamura Chemical Co., Ltd., Concentration of Solid | |
| Contents of 75 Mass %) | |
| Surfactant MEGAFAC F-780F (manufactured by DIC Corporation, | 0.05 |
| Concentration of Solid Contents of 30 Mass %) | |
| ZrO₂ Particles: Methyl Ethyl Ketone Dispersion | 3.7 |
| Liquid: OZ-S40K-AC (manufactured by NISSAN CHEMICAL | |
| INDUSTRIES, LTD., Concentration of Solid Contents of | |
| 40 Mass %) | |
| Photopolymerization Initiator IRGACURE 907: Methyl Ethyl | 4.3 |
| Ketone Solution (manufactured by BASF SE) | |
| Concentration of Solid Contents of 1 Mass % | |
| Methyl Ethyl Ketone | 60.85 |
| Methyl Isobutyl Ketone | 14.3 |
| Cyclohexanone | 15 |

—Preparation of Coating Liquid F for Layer of Low Refractive Index—

A coating liquid F for a layer of low refractive index was prepared at a composition in Table described below. The unit of each value is parts by mass.

TABLE 4

| | |
|---|---|
| Solvent Containing 4% of Compound M-11 (Solvent: | 25.94 |
| Methyl Ethyl Ketone) | |
| KAYARAD PET-30 (manufactured by Nippon Kayaku Co., Ltd.) | 0.28 |
| 7 Parts by Mass | |
| Hollow Silica Dispersion Liquid: THRULYA 4320 (manufactured | 12.29 |
| by JGC Catalysts and Chemicals Ltd) | |
| Photopolymerization Initiator IRGACURE 127 (manufactured | 0.04 |
| by BASF SE) | |
| Methyl Ethyl Ketone | 56.22 |
| Cyclohexanone | 5.22 |

A preparation method of an antireflection film of each example and comparative example will be described.

### Example 1

The coating liquid D for a hard coat layer was applied onto the surface of a TAC film (TD60UL manufactured by Fujifilm Corporation, 60 μm, a refractive index of 1.5) by using a wire bar such that the average thickness after being dried became 10 μm. After that, the coating liquid D for a hard coat layer was heated and dried at 90° C. for 1 minute, and then, was irradiated with an ultraviolet ray at irradiance of 80 mW/cm² and irradiation dose of 100 mJ/cm² by using a D bulb UV lamp for F600 (manufactured by Fusion UV Systems, Inc.) while performing nitrogen purge such that an oxygen concentration became less than or equal to 1%, and thus, a coated film was half-cured, and a hard coat layer was formed.

The coating liquid E for a layer of high refractive index was applied onto the formed hard coat layer by using a wire bar such that the average thickness after being dried became 70 nm. After that, the coating liquid E for a layer of high refractive index was heated and dried at 60° C. for 1 minute, and then, was irradiated with an ultraviolet ray at irradiance of 80 mW/cm² and irradiation dose of 100 mJ/cm² by using a D bulb UV lamp for F600 (manufactured by Fusion UV Systems, Inc.) while performing nitrogen purge such that an oxygen concentration became less than or equal to 1%, and thus, a coated film was half-cured, and a layer of high refractive index was formed.

The coating liquid C for a silver nano-disk layer was applied onto the formed layer of high refractive index by using a wire bar such that the average thickness after being dried became 20 nm. After that, the coating liquid C for a silver nano-disk layer was heated, dried, and solidified at 110° C. for 1 minute, and thus, a silver nano-disk layer was formed.

The coating liquid F for a layer of low refractive index was applied onto the formed silver nano-disk layer by using a wire bar such that the average thickness after being dried became 80 nm. After that, the coating liquid F for a layer of low refractive index was heated and dried at 60° C. for 1 minute, and was irradiated with an ultraviolet ray at irradiance of 200 mW/cm² and irradiation dose of 300 mJ/cm² by using a D bulb UV lamp for F600 (manufactured by Fusion UV Systems, Inc.) while performing nitrogen purge such that an oxygen concentration became less than or equal to 0.5%, and thus, a coated film was cured, and a layer of low refractive index was formed.

According to the procedure described above, an antireflection film of Example 1 was obtained.

### Examples 2 to 8

A hard coat layer, a layer of high refractive index, a silver nano-disk layer, and a layer of low refractive index were applied onto the surface of a TAC film (TD60UL manufactured by Fujifilm Corporation, 60 μm, A refractive index of 1.5) such that the thickness of each coated film became the numerical value shown in Table 5 in the same procedure as that in Example 1, and thus, antireflection films of Examples 2 to 8 were prepared. Here, in each of Examples 2 to 8, when a silver nano-disk dispersion liquid was prepared, the concentration, the heating temperature, and the pH of each solution at the time of being prepared were adjusted such that the thickness and the diameter became the values shown in Table 5, and when a coating liquid for a silver nano-disk layer was prepared, the concentration ratio of each solution was adjusted such that the area ratio of the silver nano-disks (silver ND) at the time of being applied became the value shown in Table 5, and thus, antireflection films of Example 2 to 8 were prepared by using silver nano-disk dispersion liquids and silver nano-disk layer coating liquids having component ratios different from each other.

### Examples 9 to 16

Antireflection films of Examples 9 to 16 were prepared in the same procedure as that in Examples 1 to 8 except that the substrate was changed to a PET film (LUMIRROR 50U 403 manufactured by TORAY INDUSTRIES, INC.).

### Comparative Example 1

An antireflection film of Comparative Example 1 was prepared by the same method as that in Example 1 except that the concentration ratio of each solution at the time of preparing the coating liquid for a silver nano-disk layer was adjusted such that the area ratio of the silver nano-disks in the silver nano-disk layer at the time of being applied became 5%.

### Comparative Example 2

An antireflection film of Comparative Example 2 was prepared by the same method as that in Example 1 except that the concentration ratio of each solution at the time of preparing the coating liquid for a silver nano-disk layer was adjusted such that the area ratio of the silver nano-disks in the silver nano-disk layer after being applied became 44%.

### Comparative Example 3

An antireflection film of Comparative Example 3 was prepared by the same method as that in Example 1 except that silver nanoparticles manufactured by Sigma-Aldrich Co. LLC. (spherical shape particles having a diameter of 20 nm and an aspect ratio of 1) were used instead of the silver nano-disk dispersion liquid at the time of preparing the coating liquid for a silver nano-disk layer.

### Comparative Example 4

An antireflection film of Comparative Example 4 was prepared by the same method as that in Example 1 except that the silver nano-disk layer was not applied, and each film thickness after being dried was changed to the value shown in Table 5 at the time of applying the layer of high refractive index and the layer of low refractive index.

### Comparative Examples 5 to 8

Antireflection films of Comparative Examples 5 to 8 were respectively prepared by the same methods as that in Comparative Examples 1 to 4 except that the transparent substrate was changed to a PET film (LUMIRROR 50U 403 manufactured by TORAY INDUSTRIES, INC.).

The layer configuration and the silver nano-disk of each of the examples and the comparative examples are collectively shown in Table 5.

TABLE 5

| | | | | | | Layer of High | | Silver | Layer of Low | | | | |
|---|---|---|---|---|---|---|---|---|---|---|---|---|---|
| | Transparent | | | Hard Coat | | Refractive | | ND | Refractive | | | | |
| | Substrate | | | Layer | | Index | | Layer | Index | | Silver ND | | |
| | | Refractive | Thick- | Refractive | Thick- | Refractive | Thick- | Thick- | Refractive | Thick- | Thick- | | Area |
| | Material | Index | ness | Index | ness | Index | ness | ness | Index | ness | ness | Diameter | Ratio |
| Example 1 | TAC | 1.5 | 80 μm | 1.5 | 8 μm | 1.6 | 70 nm | 20 nm | 1.35 | 80 nm | 8 nm | 120 nm | 15% |
| Example 2 | TAC | 1.5 | 80 μm | 1.5 | 8 μm | 1.6 | 70 nm | 20 nm | 1.35 | 80 nm | 8 nm | 120 nm | 11% |
| Example 3 | TAC | 1.5 | 80 μm | 1.5 | 8 μm | 1.6 | 70 nm | 20 nm | 1.35 | 80 nm | 8 nm | 120 nm | 22% |
| Example 4 | TAC | 1.5 | 80 μm | 1.5 | 8 μm | 1.6 | 70 nm | 20 nm | 1.35 | 80 nm | 8 nm | 120 nm | 36% |
| Example 5 | TAC | 1.5 | 80 μm | 1.5 | 8 μm | 1.6 | 90 nm | 20 nm | 1.35 | 60 nm | 8 nm | 120 nm | 20% |
| Example 6 | TAC | 1.5 | 80 μm | 1.5 | 8 μm | 1.6 | 70 nm | 20 nm | 1.35 | 80 nm | 5 nm | 90 nm | 25% |
| Example 7 | TAC | 1.5 | 80 μm | 1.5 | 8 μm | 1.6 | 70 nm | 20 nm | 1.35 | 80 nm | 15 nm | 200 nm | 12% |
| Example 8 | TAC | 1.5 | 80 μm | 1.5 | 8 μm | — | — | 20 nm | 1.35 | 80 nm | 8 nm | 120 nm | 15% |
| Example 9 | PET | 1.66 | 50 μm | 1.5 | 8 μm | 1.6 | 70 nm | 20 nm | 1.35 | 80 nm | 8 nm | 120 nm | 15% |
| Example 10 | PET | 1.66 | 50 μm | 1.5 | 8 μm | 1.6 | 70 nm | 20 nm | 1.35 | 80 nm | 8 nm | 120 nm | 11% |
| Example 11 | PET | 1.66 | 50 μm | 1.5 | 8 μm | 1.6 | 70 nm | 20 nm | 1.35 | 80 nm | 8 nm | 120 nm | 22% |
| Example 12 | PFT | 1.66 | 50 μm | 1.5 | 8 μm | 1.6 | 70 nm | 20 nm | 1.35 | 80 nm | 8 nm | 120 nm | 36% |
| Example 13 | PET | 1.66 | 50 μm | 1.5 | 8 μm | 1.6 | 90 nm | 20 nm | 1.35 | 60 nm | 8 nm | 120 nm | 20% |
| Example 14 | PET | 1.66 | 50 μm | 1.5 | 8 μm | 1.6 | 70 nm | 20 nm | 1.35 | 80 nm | 5 nm | 90 nm | 25% |
| Example 15 | PET | 1.66 | 50 μm | 1.5 | 8 μm | 1.6 | 70 nm | 20 nm | 1.35 | 80 nm | 15 nm | 200 nm | 12% |
| Example 16 | PET | 1.66 | 50 μm | 1.5 | 8 μm | — | — | 20 nm | 1.35 | 80 nm | 8 nm | 120 nm | 12% |
| Comparative | TAC | 1.5 | 80 μm | 1.5 | 8 μm | 1.6 | 70 nm | 20 nm | 1.35 | 80 nm | 8 nm | 120 nm | 5% |
| Example 1 | | | | | | | | | | | | | |
| Comparative | TAC | 1.5 | 80 μm | 1.5 | 8 μm | 1.6 | 70 nm | 20 nm | 1.35 | 80 nm | 8 nm | 120 nm | 44% |
| Example 2 | | | | | | | | | | | | | |
| Comparative | TAC | 1.5 | 80 μm | 1.5 | 8 μm | 1.6 | 70 nm | 20 nm | 1.35 | 80 nm | 20 nm | 20 nm | 25% |
| Example 3 | | | | | | | | | | | | | |
| Comparative | TAC | 1.5 | 80 μm | 1.5 | 8 μm | 1.6 | 90 nm | — | 1.35 | 100 nm | — | — | 0% |
| Example 4 | | | | | | | | | | | | | |
| Comparative | PET | 1.5 | 80 μm | 1.5 | 8 μm | 1.6 | 70 nm | 20 nm | 1.35 | 80 nm | 8 nm | 120 nm | 5% |
| Example 5 | | | | | | | | | | | | | |
| Comparative | PET | 1.5 | 80 μm | 1.5 | 8 μm | 1.6 | 70 nm | 20 nm | 1.35 | 80 nm | 8 nm | 120 nm | 44% |
| Example 6 | | | | | | | | | | | | | |
| Comparative | PET | 1.5 | 80 μm | 1.5 | 8 μm | 1.6 | 70 nm | 20 nm | 1.35 | 80 nm | 20 nm | 20 nm | 25% |
| Example 7 | | | | | | | | | | | | | |
| Comparative | PET | 1.5 | 80 μm | 1.5 | 8 μm | 1.6 | 90 nm | — | 1.35 | 100 nm | — | — | 0% |
| Example 8 | | | | | | | | | | | | | |

[Evaluation Method of Antireflection Film]

In each of the examples and the comparative examples, reflectivity A from a front surface of an antireflection structure, reflectivity B from a back surface of the antireflection structure (a transparent substrate side), a light transmittance, and a surface electrical resistance value were measured. The results are collectively shown in Table 6.

TABLE 6

| | | | | | | Surface Electrical | |
|---|---|---|---|---|---|---|---|
| | | | | | | Resistance Value | |
| | | | | | | (Radio Wave | |
| | Reflectivity A | Reflectivity B | Conditions | Transmittance | | Transmittance) | |
| Example 1 | 0.08% | 0.22% | Y | 89% | OK | 9.9 × 10¹² | OK |
| Example 2 | 0.13% | 0.35% | Y | 91% | OK | 9.9 × 10¹² | OK |
| Example 3 | 0.05% | 0.19% | Y | 87% | OK | 9.9 × 10¹² | OK |
| Example 4 | 0.63% | 1.51% | Y | 82% | OK | 9.9 × 10¹² | OK |
| Example 5 | 0.25% | 0.06% | Y | 90% | OK | 9.9 × 10¹² | OK |
| Example 6 | 0.04% | 0.28% | Y | 92% | OK | 9.9 × 10¹² | OK |
| Example 7 | 0.36% | 0.92% | Y | 86% | OK | 9.9 × 10¹² | OK |
| Example 8 | 0.21% | 0.55% | Y | 86% | OK | 9.9 × 10¹² | OK |
| Example 9 | 0.09% | 0.25% | Y | 88% | OK | 9.9 × 10¹² | OK |
| Example 10 | 0.13% | 0.36% | Y | 91% | OK | 9.9 × 10¹² | OK |
| Example 11 | 0.09% | 0.23% | Y | 86% | OK | 9.9 × 10¹² | OK |
| Example 12 | 0.65% | 1.53% | Y | 81% | OK | 9.9 × 10¹² | OK |
| Example 13 | 0.26% | 0.10% | Y | 90% | OK | 9.9 × 10¹² | OK |
| Example 14 | 0.06% | 0.32% | Y | 91% | OK | 9.9 × 10¹² | OK |
| Example 15 | 0.38% | 0.94% | Y | 85% | OK | 9.9 × 10¹² | OK |
| Example 16 | 0.22% | 0.58% | Y | 86% | OK | 9.9 × 10¹² | OK |
| Comparative | 0.12% | 0.11% | N | 93% | OK | 9.9 × 10¹² | OK |
| Example 1 | | | | | | | |
| Comparative | 2.50% | 3.13% | N | 75% | NG | 9.9 × 10¹² | OK |
| Example 2 | | | | | | | |
| Comparative | 1.30% | 1.63% | N | 72% | NG | 9.9 × 10¹² | OK |
| Example 3 | | | | | | | |
| Comparative | 0.15% | 0.15% | N | 95% | OK | 9.9 × 10¹² | OK |
| Example 4 | | | | | | | |
| Comparative | 0.14% | 0.14% | N | 93% | OK | 9.9 × 10¹² | OK |
| Example 5 | | | | | | | |
| Comparative | 2.55% | 3.22% | N | 75% | NG | 9.9 × 10¹² | OK |
| Example 6 | | | | | | | |
| Comparative | 1.29% | 1.70% | N | 72% | NG | 9.9 × 10¹² | OK |
| Example 7 | | | | | | | |
| Comparative | 0.18% | 0.17% | N | 95% | OK | 9.9 × 10¹² | OK |
| Example 8 | | | | | | | |

<Measurement Method of Reflectivity A from Front Surface>

Light was incident from the layer of low refractive index side by using a reflection film thickness spectrometer FE3000 manufactured by OTSUKA ELECTRONICS Co., LTD., a microscope was focused the substrate on the layer of low refractive index side, and thus, the reflectivity A from the front surface at a wavelength of 550 nm was measured.

<Measurement Method of Reflectivity B from Back Surface>

First, Light was incident from a side opposite to the layer of low refractive index side by using a reflection film thickness spectrometer FE3000 manufactured by OTSUKA ELECTRONICS Co., LTD., and the microscope was focused on the substrate on the side opposite to the layer of low refractive index side, and thus, reflectivity R_{ref} at a wavelength of 550 nm was measured. Next, light was incident from the substrate on the side opposite to the layer of low refractive index side, and the microscope was focused on the substrate on the layer of low refractive index side, and thus, reflectivity Rₛₐₘₚₗₑ at a wavelength of 550 nm was measured. The reflectivity B from the back surface at a wavelength of 550 nm was obtained according to the following expression by using R_{ref} and Rₛₐₘₚₗₑ.

B=Rₛₐₘₚₗₑ×(100)²/(100−R_{ref})²

In Table 6, a case where the reflectivities A and B based on the measurement results described above satisfy the conditions of the present invention was shown as Y, and a case where the reflectivities A and B based on the measurement results described above do not satisfy the conditions of the present invention was shown as N. The examples satisfy the conditions of the present invention, and the comparative examples do not satisfy the conditions of the present invention.

<Measurement Method of Transmittance>

A transmittance at a wavelength of 550 nm at the time of allowing light to be incident on the antireflection film of each of the examples from the layer of low refractive index side was measured by using a spectrophotometer U4000 manufactured by Hitachi High-Technologies Corporation. A case where the transmittance was less than 80% was evaluated as no-good (NG), and a case where the transmittance was greater than or equal to 80% was evaluated as good (OK).

<Radio Wave Transmittance>

Surface electrical resistance (Ω/Square) was measured by using a surface electrical resistance measurement device (LORESTA, manufactured by Mitsubishi Chemical Analytech Co., Ltd.), and was set as a rough standard of a radio wave transmittance. This is because it is considered that in a case where the surface electrical resistance is sufficiently large, conductivity does not exist in a plane direction, and thus, a radio wave is not hindered. In all of the examples and the comparative examples, it was determined that the surface electrical resistance values were sufficiently high (all were the detection limit values), and thus, sufficient radio wave transmittances were obtained.

As shown in Tables 5 and 6, the silver nano-disk layer was provided in the antireflection structure as with Examples 1 to 16, and the aspect ratio and the area ratio of the silver nano-disks were set to be in the range of the present invention, and thus, a relationship between the reflectivities A and B satisfied the conditions of the present invention, a light transmittance of 80% was able to be obtained, and a sufficient radio wave transmittance was able to be obtained.

On the other hand, all of the comparative examples in which the aspect ratio or the area ratio of the silver nano-disks on the silver nano-disk layer are not in the range of the present invention or the silver nano-disk layer is not included, the relationship between the reflectivities A and B does not satisfy the conditions of the present invention. In particular, in a case where the area ratio of the silver nano-disks is greater than 40%, or in a case where spherical silver particles having an aspect ratio of 1 are included, it is obvious that the transmittance remarkably decreases.

Next, functional glasses of Example 17 and Comparative Example 9 will be described.

### Example 17

In Example 17, the antireflection film of Example 1 described above adhered onto one surface of a transparent glass plate as a first antireflection film, and the antireflection film of Example 5 adhered onto the other surface as a second antireflection film through a pressure sensitive adhesive layer, respectively, and thus, functional glass was formed.

A functional glass of Example 17 was prepared as described above.

The back surface of the antireflection film of Example 1 (a surface of the transparent substrate on which the antireflection structure was not formed) was washed, and then, the pressure sensitive adhesive layer adhered thereto. PD-S1, manufactured by PANAC Corporation, including peeling sheets on both surfaces of the pressure sensitive adhesive layer was used. A surface of the pressure sensitive adhesive layer from which one peeling sheet was peeled off, was pressure-bonded to the surface of the antireflection film on which the antireflection structure was not included (that is, the back surface) by being superimposed, and thus, adhered thereto.

In the antireflection film of Example 5, the back surface of the antireflection film was similarly washed, and then, the pressure sensitive adhesive layer similarly adhered thereto.

The peeling sheet of the antireflection film of Example 1 including the pressure sensitive adhesive layer which was obtained as described above was peeled off, and the antireflection film of Example 1 adhered onto one surface of transparent glass (Thickness: 3 mm), and thus, an antireflection film adhesion structure was prepared. Next, the peeling sheet of the antireflection film of Example 5 including the pressure sensitive adhesive layer was peeled off, and the antireflection film of Example 5 adhered to the antireflection film adhesion structure (the other surface of the transparent glass), and thus, functional glass of Example 17 was prepared.

Furthermore, transparent glass which was left to stand by wiping out dusts thereon with isopropyl alcohol was used as the transparent glass, and was subjected to pressure bonding by using a rubber roller at a surface pressure of 0.5 kg/cm² under conditions of a temperature of 25° C. and humidity of 65% at the time of performing adhesion.

### Examples 18 to 23 and Comparative Examples 9 to 11

In Examples 18 to 23 and Comparative Examples 9 to 11, a first film and a second film shown in Table 7 described below respectively adhered onto one surface and the other surface of a transparent glass plate through a pressure sensitive adhesive layer, and thus, functional glass was prepared. In each of the examples, the adhesion with respect to the transparent glass of the antireflection film was performed in the same procedure as that in Example 17.

[Evaluation Method of Functional Glass]

In the functional glasses of Examples 17 to 23 and Comparative Examples 9 to 11, reflectivity C from one surface (the front surface) onto which the first antireflection film was applied, reflectivity D from the other surface (the back surface), a transmittance, and a surface electrical resistance value were measured. In each of the examples, the first film, the second film, and the results are collectively shown in Table 7.

TABLE 7

| | | | | | | | | Surface Electrical | | Difference in |
|---|---|---|---|---|---|---|---|---|---|---|
| | First Film | Second Film | Reflectivity C | Reflectivity D | Conditions | Transmittance | | Resistance Value | | Visibility |
| Example 17 | Example 1 | Example 5 | 0.23% | 0.69% | Y | 89% | OK | 9.9 × 10¹² | OK | Present |
| Example 18 | Example 2 | Example 5 | 0.31% | 0.76% | Y | 90% | OK | 9.9 × 10¹² | OK | Present |
| Example 19 | Example 3 | Example 5 | 0.27% | 0.65% | Y | 88% | OK | 9.9 × 10¹² | OK | Present |
| Example 20 | Example 4 | Example 5 | 0.82% | 1.95% | Y | 82% | OK | 9.9 × 10¹² | OK | Present |
| Example 21 | Example 6 | Example 5 | 0.25% | 0.67% | Y | 91% | OK | 9.9 × 10¹² | OK | Present |
| Example 22 | Example 7 | Example 5 | 0.57% | 1.36% | Y | 85% | OK | 9.9 × 10¹² | OK | Present |
| Example 23 | Example 8 | Example 5 | 0.43% | 0.98% | Y | 86% | OK | 9.9 × 10¹² | OK | Present |
| Comparative | Comparative | Comparative | 0.42% | 0.41% | N | 98% | OK | 9.9 × 10¹² | OK | Absent |
| Example 9 | Example 4 | Example 4 | | | | | | | | |
| Comparative | Example 5 | Example 5 | 0.43% | 0.40% | N | 90% | OK | 9.9 × 10¹² | OK | Absent |
| Example 10 | | | | | | | | | | |
| Comparative | Example 1 | Example 2 | 0.55% | 0.45% | N | 90% | OK | 9.9 × 10¹² | OK | Absent |
| Example 11 | | | | | | | | | | |

<Measurement Method of Reflectivity C from One Surface (Front Surface) of Functional Glass>

Light was incident from the surface of the functional glass by using a spectrophotometer U4000 manufactured by Hitachi High-Technologies Corporation, and the reflectivity C from the front surface at a wavelength of 550 nm at the time of allowing light to be incident on the antireflection glass of each of the examples was measured.

<Measurement Method of Reflectivity D from Other Surface (Back Surface) of Functional Glass>

Light was incident from the back surface of the functional glass by using a spectrophotometer U4000 manufactured by Hitachi High-Technologies Corporation, and the reflectivity D from the back surface at a wavelength of 550 nm at the time of allowing light to be incident on the antireflection glass of each of the examples was measured.

<Measurement Method of Transmittance>

A transmittance at a wavelength of 550 nm at the time of allowing light to be incident on the functional glass of each of the examples was measured by using a spectrophotometer U4000 manufactured by Hitachi High-Technologies Corporation. A case where the transmittance was less than 80% was evaluated as no-good (NG), and a case where the transmittance was greater than or equal to 80% was evaluated as good (OK).

<Radio Wave Transmittance>

Surface electrical resistance (Ω/Square) was measured by using a surface electrical resistance measurement device (LORESTA, manufactured by Mitsubishi Chemical Analytech Co., Ltd.), and was set as a rough standard of a radio wave transmittance. In all of the examples and the comparative examples, the surface electrical resistance value was sufficiently high, and the antireflection film was provided on the front surface and the back surface, and thus, in the functional glasses of all of the examples and the comparative examples, the surface electrical resistance value was sufficiently high (all were the detection limit values). Therefore, it was determined that a sufficient radio wave transmittance was obtained.

<Confirmation of Difference in Visibility>

In a state where a black mat board was placed on a horizontal table, and the prepared functional glass was placed thereon, reflected glare of a fluorescent lamp was visually observed. In a case of comparing the front side of the functional glass with the back side, a case where a remarkable difference was recognized in the visibility of the reflected glare of the fluorescent lamp was evaluated as difference present, and a case where a remarkable difference was not recognized in the visibility was evaluated as difference absent.

As shown in Table 7, in Examples 17 to 23, the configurations were obtained from various combinations of Examples 1 to 8, and a relationship between reflectivities C and D satisfied the functional glass of the present invention, and thus, a light transmittance of 80% was able to be obtained, and a sufficient radio wave transmittance was able to be obtained.

In contrast, in all of Comparative Examples 9 and 10 in which the same antireflection film is provided on the front surface and the back surface of the glass plate and Comparative Example 11 in which the films of Example 1 and Example 2 adhered onto the front surface and the back surface of the glass plate, the relationship between the reflectivities C and D did not satisfy the conditions of the present invention.

In a case where the reflectivity of one of the front surface and the back surface was larger than two times the reflectivity of the other one as with Examples 17 to 23, a difference was confirmed in the visibilities of the front surface and the back surface, and in a case where a large difference did not occur in the reflectivities of the front surface and the back surface, a difference was not confirmed in the visibilities of the front surface and the back surface.

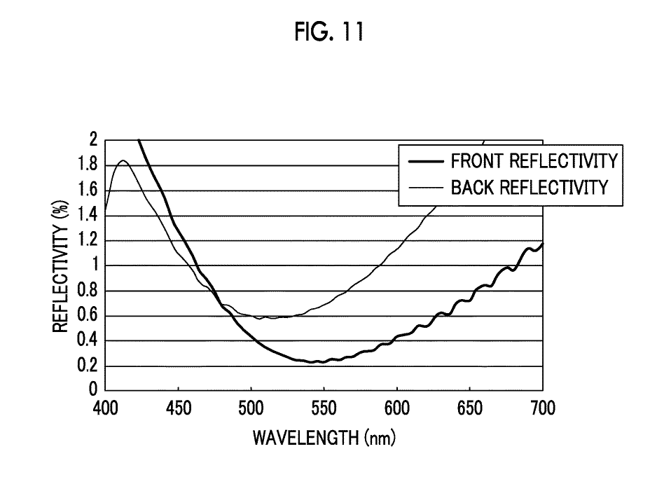

FIG. 11 is a test result of an antireflection effect illustrating wavelength dependency of reflectivity with respect to the antireflection glass of Example 17. As illustrated in FIG. 11, in the antireflection glass of Example 17, the reflectivity from the front side (one surface) was small, and excellent antireflection properties were able to be confirmed. On the other hand, it was possible to confirm that the reflection from the back side (the other surface) was larger than the reflection from the front side.

What is claimed is:

1. An antireflection film preventing an incidence ray having a wavelength λ from being reflected, comprising:
a transparent substrate; and
an antireflection structure disposed on one surface of the transparent substrate,
wherein when reflectivity in a case in which light having a wavelength λ is incident on the antireflection structure from a front surface side is set to A, and reflectivity in a case in which light having a wavelength λ is incident on the antireflection structure from a back surface side, in which the transparent substrate is present, is set to B, A and B satisfy Relational Expression (1) or (2) described below,
A<1.0% and B/A>2 (1)
B<1.0% and A/B>2 (2),
the antireflection structure includes a silver nano-disk layer formed by dispersing a plurality of silver nano-disks in a binder, and a layer of low refractive index which is formed on a surface of the silver nano-disk layer and has a refractive index smaller than a refractive index of the transparent substrate,
a ratio of a diameter of the silver nano-disk to a thickness is greater than or equal to 3, and
an area ratio of the silver nano-disk to the silver nano-disk layer is from 10% to 40%.

2. The antireflection film according to claim 1,
wherein the transparent substrate is a polyethylene terephthalate film or a triacetyl cellulose film.

3. The antireflection film according to claim 1,
wherein the layer of low refractive index is formed by dispersing a plurality of hollow silicas in a binder.

4. The antireflection film according to claim 2,
wherein the layer of low refractive index is formed by dispersing a plurality of hollow silicas in a binder.

5. The antireflection film according to claim 1,
wherein the antireflection structure includes a layer of high refractive index having a refractive index larger than the refractive index of the transparent substrate between the transparent substrate and the silver nano-disk layer.

6. The antireflection film according to claim 2,
wherein the antireflection structure includes a layer of high refractive index having a refractive index larger than the refractive index of the transparent substrate between the transparent substrate and the silver nano-disk layer.

7. The antireflection film according to claim 3,
wherein the antireflection structure includes a layer of high refractive index having a refractive index larger than the refractive index of the transparent substrate between the transparent substrate and the silver nano-disk layer.

8. The antireflection film according to claim 4,
wherein the antireflection structure includes a layer of high refractive index having a refractive index larger than the refractive index of the transparent substrate between the transparent substrate and the silver nano-disk layer.

9. The antireflection film according to claim 1,
wherein the antireflection structure includes a hard coat layer between the transparent substrate and the silver nano-disk layer.

10. The antireflection film according to claim 2,
wherein the antireflection structure includes a hard coat layer between the transparent substrate and the silver nano-disk layer.

11. The antireflection film according to claim 3,
wherein the antireflection structure includes a hard coat layer between the transparent substrate and the silver nano-disk layer.

12. The antireflection film according to claim 4,
wherein the antireflection structure includes a hard coat layer between the transparent substrate and the silver nano-disk layer.

13. The antireflection film according to claim 5,
wherein the antireflection structure includes a hard coat layer between the transparent substrate and the silver nano-disk layer.

14. The antireflection film according to claim 6,
wherein the antireflection structure includes a hard coat layer between the transparent substrate and the silver nano-disk layer.

15. The antireflection film according to claim 7,
wherein the antireflection structure includes a hard coat layer between the transparent substrate and the silver nano-disk layer.

16. The antireflection film according to claim 8,
wherein the antireflection structure includes a hard coat layer between the transparent substrate and the silver nano-disk layer.

17. A functional glass, comprising:
a glass plate;
a first antireflection film adhering to one surface of the glass plate; and
a second antireflection film adhering to the other surface of the glass plate,
wherein the first antireflection film and the second antireflection film are the antireflection film according to claim 1 and have reflection conditions different from each other, and
when reflectivity in a case in which light having a wavelength λ is incident from the one surface side is set to C, and reflectivity in a case in which the light is incident from the other surface side is set to D,
C and D satisfy Relational Expression (3) or (4) described below,
C<2.0% and D/C>2 (3)
D<2.0% and C/D>2 (4).

18. A functional glass, comprising:
a glass plate;
a first antireflection film adhering to one surface of the glass plate; and
a second antireflection film adhering to the other surface of the glass plate,
wherein the first antireflection film and the second antireflection film are the antireflection film according to claim 14 and have reflection conditions different from each other, and
when reflectivity in a case in which light having a wavelength λ is incident from the one surface side is set to C, and reflectivity in a case in which the light is incident from the other surface side is set to D,
C and D satisfy Relational Expression (3) or (4) described below,
C<2.0% and D/C>2 (3)
D<2.0% and C/D>2 (4).
